(19) United States
(12) Patent Application Publication
(10) Pub. No.: US 2022/0252399 A1
(43) Pub. Date: Aug. 11, 2022

(54) COMPOSITE SENSOR AND ANGULAR VELOCITY CORRECTION METHOD

(71) Applicant: PANASONIC INTELLECTUAL PROPERTY MANAGEMENT CO., LTD., Osaka (JP)

(72) Inventors: Atsuhito TERAO, Osaka (JP); Naoyuki TAKESUE, Tokyo (JP); Masanori SEKIGUCHI, Tokyo (JP)

(21) Appl. No.: 17/425,902

(22) PCT Filed: Jan. 20, 2020
(86) PCT No.: PCT/JP2020/001748

§ 371 Date: Jul. 26, 2021

(30) Foreign Application Priority Data
Jan. 28, 2019 (JP) 2019-012259

(51) Int. Cl. G01C 19/5776; G01P 15/18

(52) U.S. Cl. CPC G01C 19/5776; G01P 15/18

(57) ABSTRACT

A composite sensor includes an angular velocity sensor that detects angular velocity about three axes independent of one another, a first acceleration sensor that detects acceleration in directions of these three axes, a second acceleration sensor that is disposed at a position away from the first acceleration sensor and detects acceleration in a direction of at least one axis, and a computation unit that corrects the angular velocity detected by the angular velocity sensor based on the accelerations detected by the first acceleration sensor and the second acceleration sensor.

### CROSS-REFERENCE OF RELATED APPLICATIONS

This application is the U.S. National Phase under 35 U.S.C. § 371 of International Patent Application No. PCT/JP2020/001748, filed on Jan. 20, 2020, which in turn claims the benefit of Japanese Application No. 2019-012259, filed on Jan. 28, 2019, the entire disclosures of which Applications are incorporated by reference herein.

### TECHNICAL FIELD

The present disclosure relates to a composite sensor and an angular velocity correction method.

### BACKGROUND ART

There has conventionally been proposed a method of estimating information on a rigid body in a stationary reference coordinate system (such as the orientation and rotation of the rigid body) by mounting a gyroscopic sensor (an angular velocity sensor) on the rigid body so that angular velocities about three axes independent of one another can be detected. In general, a gyroscopic sensor detects angular velocities about three axes orthogonal to one another (e.g. the yaw axis, the pitch axis, and the roll axis). Then, information such as a yaw angle, a roll angle, and a pitch angle of the rigid body, information on rotation of the rigid body about a predetermined axis, and the like are obtained based on the information on the angular velocities about the three axes detected separately and independently by the gyroscopic sensor. In this way, a gyroscopic sensor detects separately and independently the angular velocities about the respective axes of a rectangular coordinate system (a rotating coordinate system) fixed to the rigid body.

Conventionally, there is also a technique for obtaining angular velocity using a plurality of acceleration sensors. For example, Patent Literature 1 describes obtaining a yaw angular acceleration from a difference between outputs from two acceleration sensors when an automobile makes a yaw motion and obtaining a yaw angular velocity by integrating the yaw angular acceleration.

### CITATION LIST

### Patent Literature

Patent Literature 1: Japanese Patent Application Publication No. Hei 6-11514

### SUMMARY OF INVENTION

### Technical Problem

However, when only an angular velocity sensor is used, the sensor is affected by differentiation error and a dead zone; thus, accurate angular velocity cannot be obtained. Also, in a case of merely using only a plurality of acceleration sensors as in Patent Literature 1, the influence of gravity cannot be eliminated. Specifically, with the technique described in Patent Literature 1, when an automobile drives up a slope and the tilt of the vehicle body changes about the pitch axis, an angular velocity output signal fluctuates.

The present disclosure has been made to solve such conventional problems, and has an object to provide a composite sensor and an angular velocity correction method which make it possible to obtain angular velocity with high precision.

### Solution to Problem

A composite sensor according to the present disclosure includes an angular velocity sensor, a first acceleration sensor, a second acceleration sensor, and a computation unit. The angular velocity sensor detects angular velocity about three axes which are independent of one another. The first acceleration sensor detects acceleration in directions of the three axes. The second acceleration sensor is disposed at a position away from the first acceleration sensor and detects acceleration in a direction of at least one axis. The computation unit corrects the angular velocity detected by the angular velocity sensor based on the accelerations detected by the first acceleration sensor and the second acceleration sensor.

An angular velocity correction method according to the present disclosure includes an angular velocity detection step, a first acceleration detection step, a second acceleration detection step, and a computation step. In the angular velocity detection step, an angular velocity sensor detects angular velocity about three axes which are independent of one another. In the first acceleration detection step, a first acceleration sensor detects acceleration in directions of the three axes. In the second acceleration detection step, a second acceleration sensor disposed at a position away from the first acceleration sensor detects acceleration in a direction of at least one axis. In the computation step, a computation unit corrects the angular velocity detected in the angular velocity detection step based on the accelerations detected in the first acceleration detection step and the second acceleration detection step.

A composite sensor according to the present disclosure includes an angular velocity sensor, a first acceleration sensor, a second acceleration sensor, and a computation unit. The angular velocity sensor detects angular velocity about two axes which are independent of each other. The first acceleration sensor detects acceleration in directions of two axes which are perpendicular to directions of the respective two axes of the angular velocity sensor. The second acceleration sensor is disposed at a position which is away in a direction perpendicular to a direction of a first one of the detection axes of the angular velocity sensor and a direction of a first one of the detection axes of the first acceleration sensor and away in a direction perpendicular to a direction of a second one of the detection axes of the angular velocity sensor and a direction of a second one of the detection axes of the first acceleration sensor, and the second acceleration sensor detects acceleration in a direction of an axis which is in a plane formed by the two axes detected by the first acceleration sensor and does not coincide with the two axes. The computation unit corrects the angular velocity detected by the angular velocity sensor based on the accelerations detected by the first acceleration sensor and the second acceleration sensor.

A composite sensor according to the present disclosure includes an angular velocity sensor, a first acceleration sensor, a second acceleration sensor, and a computation unit. The angular velocity sensor detects angular velocity about one axis. The first acceleration sensor detects acceleration in a direction of one axis which is perpendicular to a direction of the one axis of the angular velocity sensor. The second acceleration sensor is disposed at a position away in a direction perpendicular to the direction of the detection axis of the angular velocity sensor and the direction of the detection axis of the first acceleration sensor, and detects acceleration in a direction of an axis which is in a same direction as the detection axis of the first acceleration sensor. The computation unit corrects the angular velocity detected by the angular velocity sensor based on the accelerations detected by the first acceleration sensor and the second acceleration sensor.

An angular velocity correction method according to the present disclosure includes an angular velocity detection step, a first acceleration detection step, a second acceleration detection step, and a computation step. In the angular velocity detection step, the angular velocity sensor detects angular velocity about two axes which are independent of each other. In the first acceleration detection step, the first acceleration sensor detects acceleration in directions of two axes which are perpendicular to directions of the respective two axes of the angular velocity sensor. In the second acceleration detection step, the second acceleration sensor is disposed at a position away in a direction perpendicular to a direction of a first one of the detection axes of the angular velocity sensor and a direction of a first one of the detection axes of the first acceleration sensor and is away in a direction perpendicular to a direction of a second one of the detection axes of the angular velocity sensor and a direction of a second one of the detection axes of the first acceleration sensor, and detects acceleration in a direction of an axis which is in a plane formed by the two axes detected by the first acceleration sensor and does not coincide with the two axes. In the computation step, the computation unit corrects the angular velocity detected in the angular velocity detection step based on the accelerations detected in the first acceleration detection step and the second acceleration detection step.

An angular velocity correction method according to the present disclosure includes an angular velocity detection step, a first acceleration detection step, a second acceleration detection step, and a computation step. In the angular velocity detection step, the angular velocity sensor detects angular velocity about one axis. In the first acceleration detection step, the first acceleration sensor detects acceleration in a direction of one axis which is perpendicular to a direction of the one axis of the angular velocity sensor. In the second acceleration detection step, the second acceleration sensor is disposed at a position away in a direction perpendicular to the direction of the detection axis of the angular velocity sensor and the direction of the detection axis of the first acceleration sensor, and detects acceleration in a direction of an axis which is in the same direction as the detection axis of the first acceleration sensor. In the computation step, the computation unit corrects the angular velocity detected in the angular velocity detection step based on the accelerations detected in the first acceleration detection step and the second acceleration detection step.

### Advantageous Effects

The present disclosure can provide a composite sensor and an angular velocity correction method capable of obtaining angular velocity with high precision.

### BRIEF DESCRIPTION OF DRAWINGS

FIG. 1 is a functional block diagram of a composite sensor according to a first embodiment.

FIG. 2 is a configuration diagram showing an example of how a first acceleration sensor, a second acceleration sensor, and a gyroscopic sensor that the composite sensor according to the first embodiment includes are arranged, part (a) being a plan view and a part (b) being a side view.

FIG. 3 is a diagram illustrating a dead zone setting method employed by a typical composite sensor.

FIG. 4 is a diagram illustrating a dead zone setting method employed by the composite sensor according to the first embodiment.

FIG. 5 is a configuration diagram in which a stationary reference coordinate system is added to FIG. 2.

FIG. 6 is a flowchart showing an operation performed by the composite sensor according to the first embodiment.

FIG. 7 is a diagram illustrating the disposition of a second acceleration sensor of the composite sensor according to the first embodiment.

FIG. 8 is a configuration diagram showing an example of how a first acceleration sensor, a second acceleration sensor, and a gyroscopic sensor that a composite sensor according to a second embodiment includes are arranged, part (a) being a plan view and a part (b) being a side view.

FIG. 9 is a configuration diagram in which a stationary reference coordinate system is added to FIG. 8.

FIG. 10 is a flowchart showing an operation performed by the composite sensor according to the second embodiment.

FIG. 11 is a configuration diagram showing an example of how a first acceleration sensor, a second acceleration sensor, and a gyroscopic sensor that a composite sensor according to a third embodiment includes are arranged, part (a) being a plan view and a part (b) being a side view.

FIG. 12 is a configuration diagram in which a stationary reference coordinate system is added to FIG. 11.

FIG. 13 is a flowchart showing an operation performed by the composite sensor according to the third embodiment.

### DESCRIPTION OF EMBODIMENTS

With reference to the drawings, composite sensors and angular velocity correction methods according to embodiments are described below. Throughout the drawings, the same or similar portions are denoted by the same or similar reference signs.

### Composite Sensor

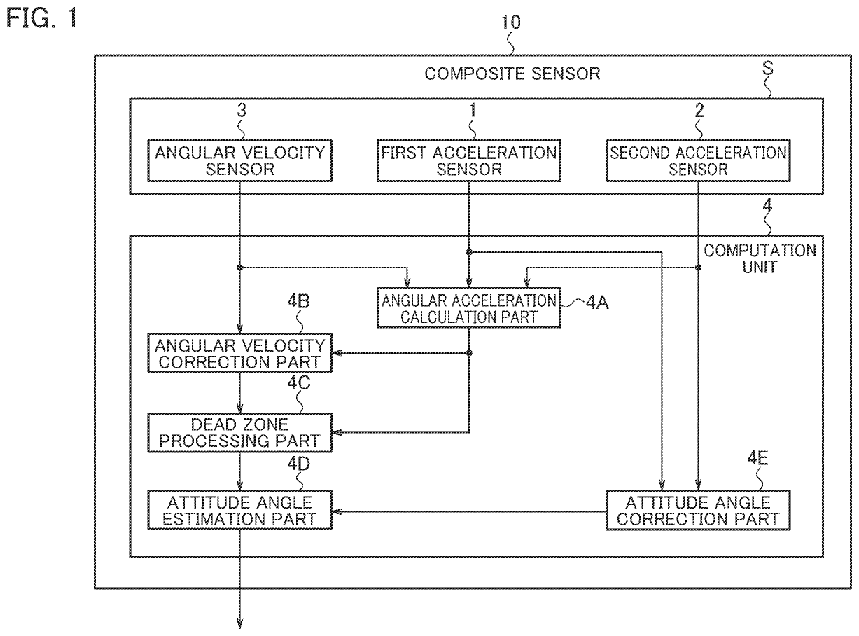

FIG. 1 is a functional block diagram of a composite sensor 10 according to a first embodiment. The composite sensor 10 is a composite sensor combining two acceleration sensors and one gyroscopic sensor and includes, as shown in FIG. 1, a first acceleration sensor 1, a second acceleration sensor 2, an angular velocity sensor 3, and a computation unit 4. The following description may refer to the first acceleration sensor 1, the second acceleration sensor 2, and the angular velocity sensor 3 collectively as a “sensor unit S.”

The computation unit 4 is a microcomputer or the like that performs various computations based on outputs from the sensor unit S, and includes parts such as angular acceleration calculation part 4A, an angular velocity correction part 4B, a dead zone processing part 4C, an attitude angle estimation part 4D, and an attitude angle correction part 4E. The angular acceleration calculation part 4A calculates the angular acceleration of a measurement target object based on accelerations detected by the first acceleration sensor 1 and the second acceleration sensor 2. The angular velocity correction part 4B corrects angular velocity detected by the angular velocity sensor 3 based on the angular acceleration calculated by the angular acceleration calculation part 4A. The dead zone processing part 4C performs dead zone processing on the angular velocity corrected by the angular velocity correction part 4B, by taking into consideration the angular acceleration calculated by the angular acceleration calculation part 4A. The attitude angle estimation part 4D estimates the attitude of the measurement target object based on the angular velocity which has been subjected to the dead zone processing by the dead zone processing part 4C. Based on the accelerations detected by the first acceleration sensor 1 and the second acceleration sensor 2, the attitude angle correction part 4E corrects an attitude angle to be used by the attitude angle estimation part 4D.

As described, the composite sensor 10 according to the first embodiment accurately corrects the output signal from the angular velocity sensor 3 based on the output signals from the first acceleration sensor 1 and the second acceleration sensor 2. Such a composite sensor 10 is applicable to various fields, such as attitude estimation and navigation of a mobile object such as an aircraft or a vehicle. The composite sensor 10, if applied to an automobile for example, can be expected to, even when the automobile drives up a slope and tilts the vehicle body about the pitch axis, obtain angular velocity with high precision to prevent a skid or overturn.

The composite sensor 10 according to the first embodiment can be formed of a total of seven axes: a tri-axial angular velocity sensor, a tri-axial acceleration sensor, and a single-axis acceleration sensor. Thus, it is only necessary to add a single-axis acceleration sensor to a typical composite sensor (a tri-axial gyroscopic sensor and a tri-axial acceleration sensor), and thus, downsizing of the sensor unit S can be expected. Generally, an angular velocity sensor means a single-axis angular velocity sensor, and an acceleration sensor means a single-axis acceleration sensor. However, no matter how many axes these sensors have, the following description refers to them simply as an “angular velocity sensor” and an “acceleration sensor”.

Although FIG. 1 shows an example where the dead zone processing part 4C is provided at a stage after the angular velocity correction part 4B, the dead zone processing part 4C may be provided at a stage before the angular velocity correction part 4B. It goes without saying that the dead zone processing part 4C in this case also performs dead zone processing which considers the angular acceleration calculated by the angular acceleration calculation part 4A.

Although not shown, like a typical sensor, the composite sensor 10 includes components such as an A/D conversion circuit that converts an analog signal to a digital signal and a storage unit that stores various kinds of data.

The first acceleration sensor 1, the second acceleration sensor 2, the angular velocity sensor 3, and the computation unit 4 may be integrated on one chip or provided over a plurality of chips. The plurality of chips may be put together in one apparatus or may be included in a plurality of apparatuses.

### Attitude Estimation Technique

The composite sensor 10 according to the first embodiment is specifically described below. The following describes an attitude estimation technique using a combination of two acceleration sensors and one gyroscopic sensor.

### 1 Introduction

A technique for estimating a current attitude with high precision and without delay plays an important role in controlling a robot such as a mobile robot moving on land, a marine robot, or a flying robot.

Airplanes and rockets are examples of objects for which high-precision attitude estimation is already achieved. High-precision attitude estimation for airplanes and rockets is achieved by use of an optical-fiber gyroscopic sensor or a ring laser gyroscopic sensor capable of obtaining angular velocity information with high precision (Reference 1); however, such optical gyroscopic sensors are expensive and difficult to reduce in size and are therefore not easily usable. Meanwhile, with the development of MEMS technology in recent years, inertial sensors are getting smaller and less expensive, but face problems of being inferior to the optical ones in terms of detection accuracy.

### 1.1 Related Art

Here, the process of estimating an attitude (Euler angles or quaternions) using information obtained from an inertial sensor is considered by being classified into the following four stages.

(i) Determine inertial sensors to use and how to arrange them.

(ii) Reduce the influence by factors such as noise by subjecting output information from each sensor to calibration or filtering (such as a Kalman filter or a complementary filter).

(iii) Calculate an attitude as seen from a stationary reference coordinate system by performing coordinate transformation and integration with respect to the output information from the sensors.

(iv) Take measures (such as using a geomagnetic sensor in combination) to reduce drift errors that gradually increase.

It goes without saying that not all the techniques reported in the past can be classified into the above four stages, but such classification makes it easy to know the positioning in the present embodiment and a prior art.

As to a technique concerning the stage (i) above, References 2 and 3 disclose methods for calculating angular acceleration using only a plurality of accelerometers. In these methods, there is discussion on only how to arrange particular accelerometers, ignoring the influence by Coriolis acceleration. There has also been proposed a method for representing the relation between angular accelerations obtained from a plurality of acceleration sensors and their angular velocity with a non-linear state space model (Reference 4).

For a technique related to the stage (ii), it has been confirmed by simulation experiment that more precise angular acceleration can be obtained with a combined usage of the method of Reference 3 and a Kalman filter (Reference 5). Also, there has also been a discussion on arranging a plurality of accelerometers on the circumference of a circle so as to analyze and calibrate errors in sensor outputs more effectively (Reference 6). There has also been proposed a method for reducing offset errors caused by temperature fluctuations in a sensor (Reference 7). Additionally, there has also been proposed a complementary filter that, with models of frequency characteristics of sensors being created, complementarily adds together signals with high reliability from the perspective of frequency characteristics out of the outputs from the sensors (References 8, 9, and 10).

As for techniques related to the stages (iii) and (iv), there have been proposed methods such as a method for estimating the roll, pitch, and yaw angles using a magnetic sensor in combination (References 11 to 16), a method for estimating quaternions (Reference 17), and a method that takes measures against local magnetic field disturbance (Reference 18).

As described above, there have been a large number of proposals about methods which use a magnetic sensor in combination as a coping technique to reduce drift errors in the yaw angle. However, using a magnetic sensor produces an adverse effect if a magnetic field disturbing factor is present near the magnetic sensor. Most mobile robots have a plurality of electric motors that are driven by permanent magnets and electromagnets; therefore, it is expected that information obtained from a magnetic sensor is low in reliability. Thus, in order to estimate the attitude of a mobile robot with high precision, it is important to obtain high-precision angular velocity information. In particular, drift errors in the yaw angle cannot be corrected using the direction of gravitational acceleration, and therefore it is desirable to obtain the angular velocity about the yaw angle with higher precision.

To perform attitude estimation using gyroscopic and acceleration sensors, one tri-axial gyroscopic sensor and one tri-axial acceleration sensor are typically used. By contrast, the first embodiment proposes an attitude estimate technique using two tri-axial acceleration sensors and one tri-axial gyroscopic sensor in combination.

### 2 Estimation of Angular Velocity and Angular Acceleration Using Two Tri-axial Acceleration Sensors and a Tri-axial Gyroscopic Sensor

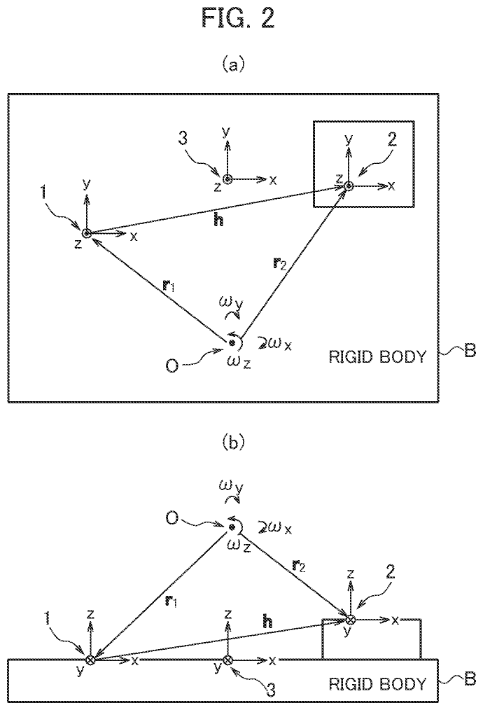

FIG. 2 is a diagram showing how two tri-axial acceleration sensors 1, 2 and a tri-axial gyroscopic sensor 3 that the composite sensor 10 according to the first embodiment includes are arranged, part (a) being a plan view and part (b) being a side view. The acceleration sensor 1, the acceleration sensor 2, and the gyroscopic sensor 3 correspond to the first acceleration sensor 1, the second acceleration sensor 2, and the angular velocity sensor 3 in FIG. 1, respectively, and are therefore described using the same reference signs.

In the first embodiment, as shown in FIG. 2, with the two tri-axial acceleration sensors 1, 2 and the tri-axial gyroscopic sensor 3 being fixed to a rigid body B, theoretical values of their sensor outputs are calculated using vector analysis.

### 2.1 Calculation of Theoretical Values Using Vector Analysis

When the two acceleration sensors 1, 2 are disposed at positions translated as shown in FIG. 2, acceleration vectors a₁, a₂ obtained by the acceleration sensor 1 and the acceleration sensor 2, respectively, are set to

[Math. 1]

a₁=[a₁ₓ a_{1y} a_{1z}]^{T}, and (1)

[Math. 2]

a₂=[a₂ₓ a_{2y} a_{2z}]^{T}. (2)

A position vector h as the acceleration sensor 2 is seen from the acceleration sensor 1 is set to

[Math. 3]

h=[hₓ h_{y} h_{z}]^{T}, (3)

and position vectors r₁, r₂ as the acceleration sensor 1 and the acceleration sensor 2 are seen from the center of rotation O are set to

[Math. 4]

r₁=[r₁ₓ r_{1y} r_{1z}]^{T}, and (4)

[Math. 5]

r₂=r₁+h

=[r₁ₓ+hₓ r_{1y}+h_{y} r_{1z}+h_{z}]^{T}. (5)

An angular velocity vector ω as the rigid body B is seen from the center of rotation O (an angular velocity vector obtained by the gyroscopic sensor 3) is set to

[Math. 6]

ω=[ωₓ ω_{y} ω_{z}]^{T}. (6)

and a gravitational acceleration vector g acting on the rigid body B as seen from the rigid body B (a sensor coordinate system Σxyz) is set to

[Math. 7]

g=[gₓ g_{y} g_{z}]^{T}. (7)

Then, the acceleration vector a₁, a₂ obtained by the acceleration sensors 1, 2 are as follows:

[Math. 8]

a₁=\ddot{r}₁+\dot{ω}×r₁+2ω×\dot{r}₁+ω×(ω×r₁)+g, and (8)

[Math. 9]

a₂=\ddot{r}₂+\dot{ω}×r₂+2ω×\dot{r}₂+ω×(ω×r₂)+g. (9)

(Hereinbelow, a time derivative may be denoted as d/dt instead of an overdot.) In the above formula, d²r₁/dt² and d²r₂/dt² each represent a translational acceleration, dω/dt×r₁ and dω/dt×r₂ each represent a tangential acceleration, 2ω×dr₁/dt and 2ω×dr₂/dt each represent a Coriolis acceleration, and ω×(ω×r₁) and ω×(ω×r₂) each represent a centrifugal acceleration.

The difference between Formula (8) and Formula (9) is as follows:

$$[ Math . 10 ]$$

$$\begin{matrix}{a}_{2} - {a}_{1} = {\ddot{r}}_{2} - {\ddot{r}}_{1} + \dot{ω} \times ( {r}_{2} - {r}_{1} ) + 2 ω \times \\ ( {\dot{r}}_{2} - {\dot{r}}_{1} ) + ω \times \{ ω \times ( {r}_{2} - {r}_{1} ) \} \\ = \dot{ω} \times h + ω \times ( ω \times h ) \\ = ( \dot{Ω} \times {Ω}^{2} ) h .\end{matrix} \qquad ( 10 )$$

In the above formula, Ω represents a matrix of cross products of the vector ω and is expressed as follows:

$$[ Math . 11 ]$$

$$Ω = [ \begin{matrix}0 & - {ω}_{z} & {ω}_{y} \\ {ω}_{z} & 0 & - {ω}_{x} \\ - {ω}_{y} & {ω}_{x} & 0\end{matrix} ] . \qquad ( 11 )$$

The matrix Ω is an alternating matrix (Ω^{T}=−Ω), and its eigenvalues are all pure imaginary numbers or 0 (zero) (irregular).

Further, when

$$[ Math . 12 ]$$

$$\begin{matrix}x = {[ \begin{matrix}{x}_{1} & {x}_{2} & {x}_{3}\end{matrix} ]}^{T} \\ = Ω h , and\end{matrix} \qquad ( 12 )$$

$$[ Math . 13 ]$$

$${\begin{matrix}u = [ \begin{matrix}{u}_{1} & {u}_{2} & {u}_{3}\end{matrix} ] \\ = {a}_{2} - {a}_{1} ,\end{matrix}}^{T} \qquad ( 13 )$$

Formula (10) can be expressed as follows:

[Math. 14]

\dot{x}=−Ωx+u. (14)

### 2.2 When the Acceleration Sensors are Arranged such that h=[hₓ 0 0]^{T}

The acceleration sensor 2 is disposed relative to the acceleration sensor 1 such that

$$[ Math . 15 ]$$

$$h = {[ \begin{matrix}{h}_{x} & 0 & 0\end{matrix} ]}^{T} . Then , \qquad ( 15 )$$

$$[ Math . 16 ]$$

$$\dot{x} = \dot{Ω} h = {h}_{x} [ \begin{matrix}0 \\ {\dot{ω}}_{z} \\ - {\dot{ω}}_{y}\end{matrix} ] , and \qquad ( 16 )$$

$$[ Math . 17 ]$$

$$- Ω x = {h}_{x} [ \begin{matrix}{ω}_{z}^{2} + {ω}_{y}^{2} \\ - {ω}_{x} {ω}_{y} \\ - {ω}_{x} {ω}_{y}\end{matrix} ] , \qquad ( 17 )$$

and substituting these into Formula (14) yields

[Math. 18]

0=hₓ(ω_{z}²+ω_{y}²)+u₁, (18)

[Math. 19]

hₓ\dot{ω}_{z}=−hₓωₓω_{y}+u₂, and (19)

[Math. 20]

−hₓ\dot{ω}_{y}=−hₓωₓω_{z}+u₃. (20)

### Based on Formula (19),

$$[ Math . 21 ]$$

$${\dot{ω}}_{z} = \frac{{u}_{2}}{{h}_{x}} - {ω}_{x} {ω}_{y} . \qquad ( 21 )$$

The value dω_{z}/dt obtained by using the above formula is not one obtained by differentiation of a z-axis-direction output ω_{z} from the gyroscopic sensor 3. Thus, it is expected that applying a Kalman filter to dω_{z}/dt obtained by Formula (21) and ω_{z} obtained from the output from the gyroscopic sensor 3 allows the yaw angle's angular velocity of a measurement target object to be obtained with high precision.

Also, since u₂=a_{2y}−a_{1y}, it can be seen that the precision of the acceleration sensors 1, 2 concerning the y-axis direction (a direction orthogonal to both the yaw axis and the vector h) is important in order to calculate the yaw angle's angular acceleration dω_{z}/dt.

### 3 Correction of Interindividual Difference Using the Least-Squares Method

The theory described above does not consider the influence by errors caused by observation noise and sensor properties. However, the acceleration vectors ^{s}a₁, ^{s}a₂ detected by the acceleration sensors 1, 2 actually contain errors. When errors contained in the acceleration sensor 1 and the acceleration sensor 2 are respectively

[Math. 22]

Δa₁=[Δa₁ₓ Δa_{1y} Δa_{1z}]^{T}, and (22)

[Math. 23]

Δa₂=[Δa₂ₓ Δa_{2y} Δa_{2z}]^{T}, (23)

the acceleration vectors ^{s}a₁, ^{s}a₂ are respectively

[Math. 24]

^{s}a₁=a₁+Δa₁, and (24)

[Math. 25]

^{s}a₂=a₂+Δa₂. (25)

The acceleration vectors a₁, a₂ are theoretical acceleration vectors obtained by the acceleration sensors 1, 2, and acceleration vectors ^{s}a₁, ^{s}a₂ are actual error-containing acceleration vectors outputted from the acceleration sensors 1, 2.

When ω=0 and dω/dt=0, the difference between Formula (24) and Formula (25) is

[Math. 26]

^{s}a₁−^{s}a₂=(a₁−a₂)+(Δa₁−Δa₂)

=(Δa₁−Δa₂)

^{s}a₁=^{s}a₂+(Δa₁−Δa₂), (26)

and Δa₁−Δa₂ can be interpreted as the interindividual difference between the acceleration sensor 1 and the acceleration sensor 2. Thus, it is considered here that the interindividual difference is corrected by application of a certain appropriate projection transformation matrix Q to the output ^{s}a₂ from the acceleration sensor 2.

When ω=0 and dω/dt=0, acceleration information obtained from the two acceleration sensors 1, 2 at a time t are ^{s}a₁(t), ^{s}a₂(t). Then, there are a matrix Q and a vector Δα(t) satisfying the following:

[Math. 27]

^{s}a₁(t)=Q^{s}a₂(t)+Δα(t). (27)

When Q=I (an identity matrix), Δα(t)=Δa₁(t)−Δa₂(t), and Formula (27) agrees with Formula (26). The interindividual difference can be corrected by obtaining a matrix Q that minimizes Δα^{T}Δα and handling the acceleration information obtained by the acceleration sensor 2 as Q^{s}a₂(t).

When the two acceleration sensors 1, 2 are motionless with the same attitude (receiving the same gravitational acceleration), matrices A, B are defined as follows using acceleration information obtained at times t₁ . . . tₙ:

[Math. 28]

A=[^{s}a₁(t₁) . . . ^{s}a₁(tₙ)], and (28)

[Math. 29]

B=[^{s}a₂(t₁) . . . ^{s}a₂(tₙ)], (29)

Then, if the matrix B^{T}B is regular, the matrix that minimizes Δα^{T}Δα is as follows:

[Math. 30]

Q=A(B^{T}B)⁻¹B^{T}. (30)

### 4 The Relation between the Precision of the Acceleration Sensors and Inter-Sensor Distance

For downsizing of the above-described sensor system, the smaller the distance ∥h∥ between the two acceleration sensors 1, 2, the better. It is theoretically possible to shorten ∥h∥ boundlessly, but in actuality, there is a limit to shortening ∥h∥ due to influences such as noise. Thus, in the first embodiment, a description is given on the relation between observational errors Δa₁, Δa₂ contained in the acceleration sensors 1, 2 and the inter-sensor distance ∥h∥. When the difference between the errors contained in the outputs from the acceleration sensors 1, 2 is

$$[ Math . 31 ]$$

$$\begin{matrix}Δ u = {[ \begin{matrix}Δ {u}_{1} & Δ {u}_{2} & Δ\end{matrix} {u}_{3} ]}^{T} \\ = Δ {a}_{2} - Δ {a}_{1} ,\end{matrix} \qquad ( 31 )$$

the difference between the acceleration vectors ^{s}a₁, ^{s}a₂ obtained from the outputs from the acceleration sensors 1, 2 is

$$[ Math . 32 ]$$

$$\begin{matrix}{}^{s} {a}_{2} - {}^{s} {a}_{1} = {a}_{2} - {a}_{1} + Δ {a}_{2} - Δ {a}_{1} \\ = u + Δ u .\end{matrix} \qquad ( 32 )$$

Then, when Formula (21) is expressed considering an error Δu,

$$[ Math . 33 ]$$

$$\begin{matrix}{\dot{ω}}_{z} = \frac{{u}_{2} + Δ {u}_{2}}{{h}_{x}} - {ω}_{x} {ω}_{y} \\ = \frac{{u}_{2}}{{h}_{x}} + \frac{Δ {u}_{2}}{{h}_{x}} - {ω}_{x} {ω}_{y} .\end{matrix} \qquad ( 33 )$$

The above formula shows that the larger hₓ, the smaller the influence that the error Δu₂ has, and conversely, the smaller hₓ, the larger the influence that the error has. Thus, it has been found that reducing hₓ and diminishing the influence by the error have a tradeoff relation with each other.

### 5 Dead Zone Setting Method using Angular Acceleration in Combination

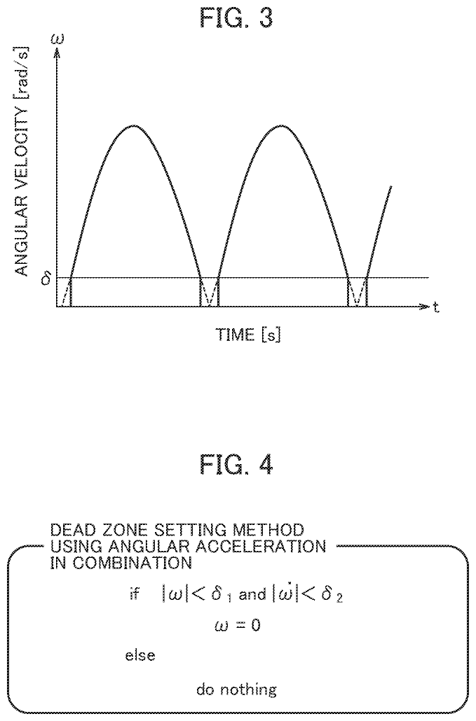

In a case where a dead zone with a magnitude δ is provided for an angular velocity ω, angular velocity cannot be detected correctly in a region where the magnitude of the angular velocity is δ or below (FIG. 3). However, as shown in FIG. 3, the slope is steep even in the region where the magnitude of the angular velocity is δ or below, and therefore the angular acceleration shows a large value. Thus, use of a dead zone setting method using both angular velocity and angular acceleration allows detection of the parts indicated by the dotted lines in FIG. 3 and therefore solves the above problem. FIG. 4 shows its pseudo-code.

As shown in FIG. 4, in the first embodiment, ω=0 is set when the conditions |ω|<δ₁ and |dω/dt|δ₂ are both satisfied, and nothing is done otherwise. Such a dead zone setting method can be expected to produce its advantageous effect particularly when a motionless state and a moving state are repeated at very short intervals or when the angular velocity is low.

Depending on the applications, it is important to obtain angular velocity information without missing any of the information during a low angular velocity time. For example, assume that a user wants to make a two-wheel-drive mobile robot go straight. Then, the robot's body gradually turns due to the interindividual difference between the left and right drive wheels. If this problem is sought to be solved using an attitude estimation technique using inertial sensors, low angular velocity needs to be obtained.

### 6 Method of Conversion to Attitude Angles

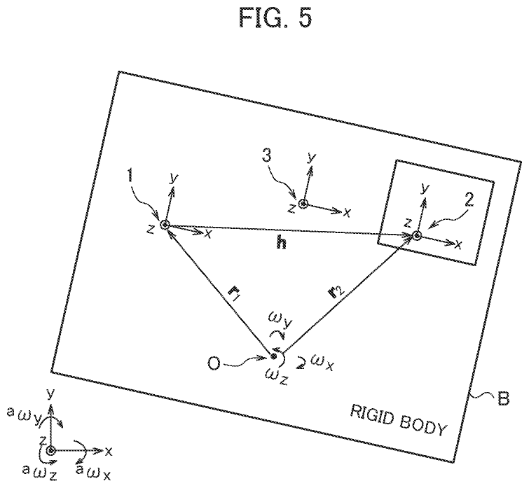

FIG. 5 is a diagram in which a stationary reference coordinate system ΣXYZ is added to FIG. 2 and represents the attitude (roll, pitch, and yaw angles) of the rigid body B as seen from the stationary reference coordinate system ΣXYZ. As compared to this stationary reference coordinate system, the coordinate system on the rigid body B can be called a moving coordinate system. A vector representing the attitude (roll, pitch, and yaw angles) of the rigid body B seen from the stationary reference coordinate system ΣXYZ is

[Math. 34]

θ=[θ_{R} θ_{P} θ_{Y}]^{T}. (34)

If the acceleration sensors 1, 2 detect only gravitational acceleration,

$$[ Math . 35 ]$$

$${θ}_{R} = {tan}^{- 1} ( \frac{{a}_{1 y}}{{a}_{1 z}} ) = {tan}^{- 1} ( \frac{{a}_{2 y}}{{a}_{2 z}} ) and \qquad ( 35 )$$

$$[ Math . 36 ]$$

$$\begin{matrix}{θ}_{P} = {tan}^{- 1} ( \frac{- {a}_{1 x}}{\sqrt{{a}_{1 y}^{2} + {a}_{1 z}^{2}}} ) \\ = {tan}^{- 1} ( \frac{- {a}_{2 x}}{\sqrt{{a}_{2 y}^{2} + {a}_{2 z}^{2}}} )\end{matrix} \qquad ( 36 )$$

hold true. In other words, a roll angle θ_{R} and a pitch angle θ_{P} can be obtained only from the outputs from the acceleration sensors 1, 2. In addition, if the acceleration sensors 1, 2 detect only gravitational acceleration, the following formulae hold true.

[Math. 37]

∥a₁∥=g and ∥a₂∥=g (37)

However, the opposite does not necessarily hold true. Specifically, even if Formulae (37) are satisfied, it does not necessarily mean that the acceleration sensors 1, 2 detect only gravitational acceleration. For example, there is a case where the sensor system is falling in the direction of gravitational force at an acceleration of 2 g. However, such a phenomenon rarely occurs, and therefore in practice, a problem seldom occurs even if Formulae (37) are used to determine whether only gravitational acceleration is detected. In addition, when cos θ_{P}≠0,

$$[ Math . 38 ]$$

$$\frac{d}{dt} θ = [ \begin{matrix}1 & sin {θ}_{R} tan {θ}_{P} & cos {θ}_{R} tan {θ}_{P} \\ 0 & cos {θ}_{R} & - sin {θ}_{R} \\ 0 & sin {θ}_{R} / cos {θ}_{P} & cos {θ}_{R} / cos {θ}_{P}\end{matrix} ] ω \qquad ( 38 )$$

(References 19, 20). Reference 21 shows how to derive the above formula. An attitude angle can be obtained by integration of a derivative of the attitude angle obtained by Formula (38). Although the method shown in the first embodiment converts an output from the gyroscopic sensor 3 into a derivative of an attitude angle, there is also a method of obtaining quaternions representing the current attitude by converting an output from the gyroscopic sensor 3 into derivatives of quaternions.

### 7 Operation

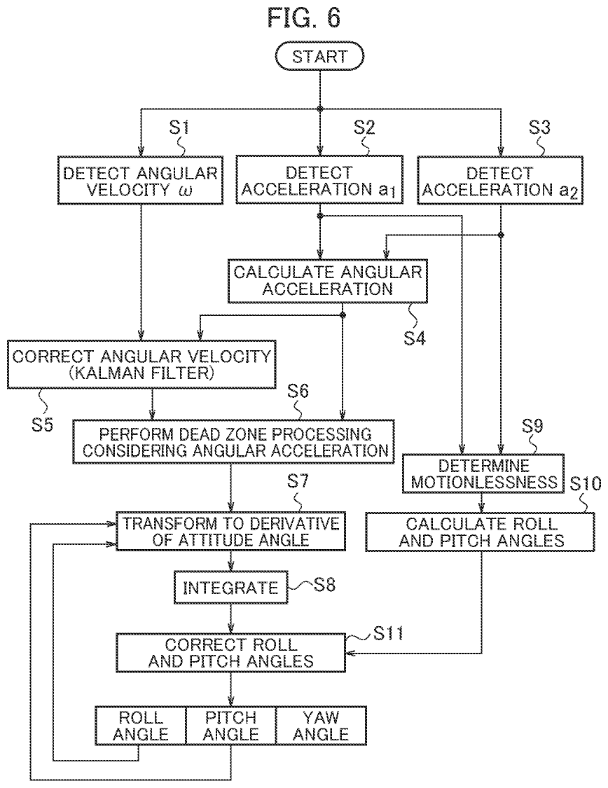

FIG. 6 is a flowchart showing the operation of the composite sensor 10 according to the first embodiment. With reference to FIG. 6, a description is given below on an operation for obtaining an attitude angle using the above-described method.

First, the gyroscopic sensor 3 detects an angular velocity vector ω, the acceleration sensor 1 detects an acceleration vector a₁, and the acceleration sensor 2 detects an acceleration vector a₂ (Steps S1, S2, S3). The output from the gyroscopic sensor 3, the output from the acceleration sensor 1, and the output from the acceleration sensor 2 are inputted to the computation unit 4 at a later stage.

Next, based on the output from the gyroscopic sensor 3, the output from the acceleration sensor 1, and the output from the acceleration sensor 2, the computation unit 4 calculates an angular acceleration dω_{z}/dt about the yaw angle using Formula (21) (Step S4). Then, the computation unit 4 corrects the output (the angular velocity) from the gyroscopic sensor 3 by applying a Kalman filter to dω_{z}/dt obtained by Formula (21) and ω_{z} obtained from the output from the gyroscopic sensor 3 (Step S5). Although the Kalman filter is used as an example here, an algorithm for correcting the angular velocity is not limited to this.

Also, the computation unit 4 performs dead zone processing considering the angular acceleration (Step S6). Specifically, the computation unit 4 sets ω=0 if the conditions |ω|<δ₁ and |dω/dt|<δ₂ are both satisfied, and does nothing otherwise.

Further, the computation unit 4 obtains an attitude angle (a roll angle, a pitch angle, a yaw angle) by integrating a derivative of an attitude angle obtained by Formula (38) (Steps S7 to S8).

Meanwhile, the computation unit 4 performs motionlessness determination based on the output from the acceleration sensor 1 and the output from the acceleration sensor 2 (Step S9). Specifically, if the measurement target object is motionless, the computation unit 4 calculates a roll angle and a pitch angle using Formulae (35) and (36) and corrects the roll angle and pitch angle to be used in Step S7 (Steps 10 to S11).

### 8 Summary

The following is a summary of the characteristics of the above-described attitude estimation technique.

(1) The attitude estimation technique is applicable when at least a total of seven axes, namely, a tri-axial gyroscopic sensor, a tri-axial acceleration sensor, and a single-axis acceleration sensor, are used.
(2) To add one acceleration sensor, Formula (21) needs to be derived.
(3) Use of one additional acceleration sensor allows the angular acceleration of a measurement target object to be obtained without using differentiation. It is generally known that information obtained by differentiation has an instantaneously large error due to such influences as noise.
(4) Use of the angular acceleration obtained allows correction (Kalman filter) to be made on the angular velocity obtained from the gyroscopic sensor, and therefore it is expected that the angular velocity of a measurement target object can be obtained with higher precision.
(5) It is expected that application of a dead zone using angular acceleration in combination can prevent missing of a part of angular velocity information at a time when the angular velocity is low.

As described earlier, the composite sensor 10 according to the first embodiment includes the angular velocity sensor 3, the first acceleration sensor 1, the second acceleration sensor 2, and the computation unit 4. The angular velocity sensor 3 detects angular velocity about three axes which are independent of one another. The first acceleration sensor 1 detects acceleration in directions of the three axes. The second acceleration sensor 2 is disposed at a position away from the first acceleration sensor 1 and detects acceleration in a direction of at least one axis. The computation unit 4 corrects the angular velocity detected by the angular velocity sensor 3 based on the accelerations detected by the first acceleration sensor 1 and the second acceleration sensor 2. Since the output signal from the angular velocity sensor 3 is thus corrected based on the output signals from the first acceleration sensor 1 and the second acceleration sensor 2, the composite sensor 10 capable of obtaining angular velocity with high precision can be provided.

It is desirable that the second acceleration sensor 2 be disposed at a position away from the first acceleration sensor 1 not only in a particular one of the three axes. As long as this disposition condition is satisfied, the output signal from the angular velocity sensor 3 can be corrected based on the output signals from the first acceleration sensor 1 and the second acceleration sensor 2 even if a single-axis acceleration sensor is used for the second acceleration sensor 2.

It is also desirable that when the disposition of the second acceleration sensor 2 relative to the first acceleration sensor 1 is a vector h=[hₓ 0 0]^{T}, the second acceleration sensor 2 detect acceleration in a direction which is orthogonal to both of a particular one axis and the vector h. For example, to obtain angular velocity about a particular one axis (z-axis), precise detection in a direction (y-axis direction) orthogonal to both the particular one axis (z-axis) and the vector h allows high-precision correction of the output signal from the angular velocity sensor 3.

It is desirable that the computation unit 4 obtain the angular acceleration of a measurement target object based on the accelerations detected by the first acceleration sensor 1 and the second acceleration sensor 2 without using differentiation and correct the angular velocity detected by the angular velocity sensor 3 by using the angular acceleration thus obtained. Obtaining the angular acceleration of a measurement target object without using differentiation has an advantageous effect of being less subject to influences such as noise.

It is also desirable that the computation unit 4 obtain an angular acceleration about the z-axis of a measurement target object using Formula (21) when the disposition of the second acceleration sensor 2 relative to the first acceleration sensor 1 is the vector h=[hₓ 0 0]^{T}. When the vector h=[hₓ 0 0]^{T}, the disposition of the sensor unit S is simplified, and also, the angular acceleration about the z-axis of a measurement target object can be obtained using a simple computation like Formula (21).

It is also desirable that the computation unit 4 set a dead zone with a magnitude δ₁ for the angular velocity detected by the angular velocity sensor 3 and also sets a dead zone with a magnitude δ₂ for the angular acceleration obtained based on the accelerations detected by the first acceleration sensor 1 and the second acceleration sensor 2. Such a dead zone setting method is expected to offer its advantageous effect particularly when a motionless state and a moving state are repeated at very short intervals or when the angular velocity is low.

In addition, the angular velocity correction method according to the first embodiment includes an angular velocity detection step, a first acceleration detection step, a second acceleration detection step, and a computation step. In the angular velocity detection step, the angular velocity sensor 3 detects angular velocity about three axes which are independent of one another. In the first acceleration detection step, the first acceleration sensor 1 detects acceleration in the directions of these three axes. In the second acceleration detection step, the second acceleration sensor 2 which is disposed at a position away from the first acceleration sensor 1 detects acceleration in a direction of at least one axis. In the computation step, the computation unit 4 corrects the angular velocity detected in the angular velocity detection step based on the accelerations detected in the first acceleration detection step and the second acceleration detection step. Since the output signal from the angular velocity sensor 3 is thus corrected based on the output signals from the first acceleration sensor 1 and the second acceleration sensor 2, an angular velocity correction method capable of obtaining angular velocity with high precision can be provided.

### 9 REFERENCES

The following lists the references.
[Reference 1] OHNO Aritaka: Recent Technical Progress of the Gyroscope, Journal of the Japan Society for Precision Engineering, vol. 75, no. 1, pp. 159-160, 2009.
[Reference 2] Peter G. Martin, Gregory W. Hall, Jeff R. Crandall, and Walter D. Pilkey: Measuring the Acceleration of a Rigid Body, Shock and Vibration, vol. 5, no. 4, pp. 211-224, 1998.
[Reference 3] A. J. Padgaonkar, K. W. Krieger and A. I. King: Measurement of Angular Acceleration of a Rigid Body Using Linear Accelerometers, ASME Journal of Applied Mechanics, vol. 42, no. 3, pp. 552-556, 1975.
[Reference 4] Patrick Schopp, Hagen Graf, Michael Maurer, Michailas Romanovas, Lasse Klingbeil, and Yiannos Manoli: Observing Relative Motion With Three Accelerometer Triads, IEEE Transactions on Instrumentation and Measurement, vol. 63, no. 12, pp. 3137-3151, 2014.
[Reference 5] OHTA Ken and KOBAYASHI Kazutoshi: Measurement of Angular Velocity and Angular Acceleration in Sports Using Accelerometers, Transactions of the Society of Instrument and Control Engineers, vol. 30, no. 12, pp. 1442-1448, 1994.
[Reference 6] MIMURA Nobuharu, ONODERA Ryoji, and KOMATSUBARA Ryo: An Error Analysis and Efficient Calibration Method for 6 DOF Acceleration Sensor Systems Using Multiple Dual-Axis Accelerometers, Transactions of the Japan Society of Mechanical Engineers (Series C), vol. 74, no. 739, pp. 134-140, 2008.
[Reference 7] FUJITA Koumei, NAKAHARA Mitsuya, SATOU Hiroyuki, and TERAO Atsuhito: High-Precision Motion Sensing Unit for Robots, Panasonic Technical Journal, vol. 63, no. 2, pp. 30-34, 2017.
[Reference 8] SUGIHARA Tomomichi, MASUYA Ken, and YAMAMOTO Motoji: A Complementary Filter for High-fidelity Attitude Estimation based on Decoupled Linear/Nonlinear Properties of Inertial Sensors, Journal of the Robotics Society of Japan, vol. 31, no. 3, pp. 251-262, 2013.
[Reference 9] A. El Hadri and A. Benallegue: Attitude estimation with gyros-bias compensation using low-cost sensors, Proceeding of the 48th Conference on Decision and Control, pp. 8077-8082, 2009.
[Reference 10] A. J. Baerveldt and R. Klang: A low-cost and low-weight attitude estimation system for an autonomous helicopter, Intelligent Engineering System, pp. 391-395, 1997.
[Reference 11] Jurman D, Jankovec M, Kamnik R, Topic M: Calibration and data fusion solution for the miniature attitude and heading reference system, Sensors and Actuators A, vol. 138, no. 2, pp. 411-420, 2007.
[Reference 12] Foxlin E: Inertial head-tracker sensor fusion by a complementary separate-bias Kalman filter, IEEE Proceedings of VRAIS, pp. 185-194, 1996.
[Reference 13] Vahanay J, Aldon M J, Fournier A: Mobile robot attitude estimation by fusion of inertial data, Proceedings of the IEEE International Conference on Robotics and Automation, pp. 277-282, 1993.
[Reference 14] Ying-Chih Lai, Shau-Shiun Jan and Fei-Bin Hsiao: Development of a Low-Cost Attitude and Heading Reference System Using a Three-Axis Rotating Platform, sensors, vol. 10, no. 4, pp. 2472-2491, 2010.
[Reference 15] Tae Suk Yoo, Sung Kyung Hong, Hyok Min Yoon and Sungsu Park: Gain-Scheduled Complementary Filter Design for a MEMS Based Attitude and Heading Reference System, sensors, vol. 11, no. 4, pp. 3816-3830, 2011.
[Reference 16] HIROSE Kiyoshi, DOKI Hitoshi, and KONDO Akiko: Studies on Orientation Measurement in Sports Using Inertial and Magnetic Field Sensors, Japan journal of sports industry, vol. 22, no. 2, pp. 255-262, 2012.
[Reference 17] Sabatini A. M.: Quaternion-based extended Kalman filter for determining orientation by inertial and magnetic sensing, IEEE Transactions on Biomedical Engineering, vol. 53, no. 7, pp. 1346-1356, 2006.
[Reference 18] Roetenberg D, Luinge H J, Baten C T, and Veltink P H: Compensation of Magnetic Disturbances Improves Inertial and Magnetic Sensing of Human Body Segment Orientation, IEEE transaction on Neural Systems and Rehabilitation Engineering, vol. 13, no. 3, pp. 395-405, 2005.
[Reference 19] HIROSE Kiyoshi and KONDO Akiko—Measurement Technique for Ergonomics, Japan Human Factors and Ergonomics Society, vol. 50, no. 4, pp. 182-190, 2014.
[Reference 20] Cooke J. M., Zyda M. J., Pratt D. R., and McGhee R. B.: Flight simulation dynamic modeling using quaternions, NPSNET, vol. 1, no. 4, pp. 404-420, 1994.
[Reference 21] HASEGAWA Ritsuo: General Method Deriving Kinematic Equations for Rotation Representations, Transactions of the Society of Instrument and Control Engineers, vol. 40, no. 11, pp. 1160-1162, 2004.

### 10 Disposition of the Second Acceleration Sensor Relative to the First Acceleration Sensor

When rotation of a rigid body is considered using a composite sensor, rotations about the respective axes may be regarded separately and independently with a rectangular coordinate system fixed to the rigid body set as a reference coordinate system. Thus, the following describes a method for obtaining angular acceleration with two acceleration sensors by considering the rotations about three axes, the x-axis, the y-axis, and the z-axis, which are fixed to the rigid body and are orthogonal to one another.

### 10.1 Preconditions

First, as preconditions, a description is given on the basic properties of rotation about one axis of the rectangular coordinate system. The following description of the basic properties of rotation about one axis mainly uses the rotation about the z-axis.

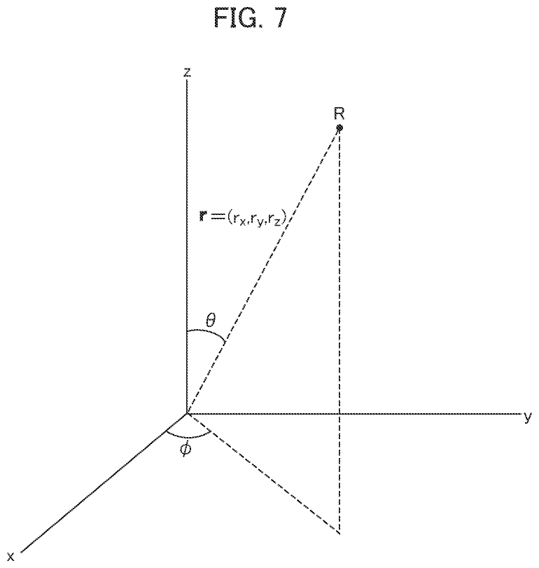

As shown in FIG. 7, a point P in a space can be typically represented with a vector r=(rₓ, r_{y}, r_{z}) as seen from a reference point such as the origin. When θ is an angle formed between the vector r and the z-axis and φ is an angle formed between the vector r as seen along the z-axis (the vector r projected onto the xy plane (a plane orthogonal to the z-axis)) and the x-axis, the vector r can be expressed as Formula (39).

$$[ Math . 39 ]$$

$$r = \sqrt{{r}_{x}^{2} + {r}_{y}^{2} + {r}_{z}^{2}} , \\ {r}_{x} = r sin θcosϕ , \\ {r}_{y} = r sin θsinϕ , \\ {r}_{z} = r cos θ , sin θ = \frac{\sqrt{{r}_{x}^{2} + {r}_{y}^{2}}}{\sqrt{{r}_{x}^{2} + {r}_{y}^{2} + {r}_{z}^{2}}} , \\ cos θ = \frac{{r}_{z}}{\sqrt{{r}_{x}^{2} + {r}_{y}^{2} + {r}_{z}^{2}}} , \\ sin ϕ = \frac{{r}_{ν}}{\sqrt{{r}_{x}^{2} + {r}_{y}^{2} + {r}_{z}^{2}}} , \\ cos ϕ = \frac{{r}_{x}}{\sqrt{{r}_{x}^{2} + {r}_{y}^{2}}} \qquad ( 39 )$$

Thus, when r₁=(r₁ₓ, r_{1y}, r_{1z}) is a position vector of the acceleration sensor 1 as seen from the center of rotation O of the rigid body B, θ₁ is an angle formed between the vector r₁ and the z-axis (an axis corresponding to the angular acceleration component to be obtained), and φ₁ is an angle formed between the vector r₁ as seen along the z-axis (the vector r₁ projected onto the xy plane (the plane orthogonal to the z-axis)) and the x-axis, the vector r₁ can be expressed as Formula (40).

$$[ Math . 40 ]$$

$${r}_{1} = \sqrt{{r}_{1 x}^{2} + {r}_{1 y}^{2} + {r}_{1 z}^{2}} , \\ {r}_{1 x} = {r}_{1} sin {θ}_{1} cos {ϕ}_{1} , \\ {r}_{1 y} = {r}_{1} sin {θ}_{1} sin {ϕ}_{1} , \\ {r}_{1 z} = {r}_{1} cos {θ}_{1} , sin {θ}_{1} = \frac{\sqrt{{r}_{1 x}^{2} + {r}_{1 y}^{2}}}{\sqrt{{r}_{1 x}^{2} + {r}_{1 y}^{2} + {r}_{1 z}^{2}}} , \\ cos {θ}_{1} = \frac{{r}_{1 z}}{\sqrt{{r}_{1 x}^{2} + {r}_{1 y}^{2} + {r}_{1 z}^{2}}} , \\ sin {ϕ}_{1} = \frac{{r}_{1 y}}{\sqrt{{r}_{1 x}^{2} + {r}_{1 y}^{2}}} , \\ cos {ϕ}_{1} = \frac{{r}_{1 y}}{\sqrt{{r}_{1 x}^{2} + {r}_{1 y}^{2}}} \qquad ( 40 )$$

In addition, when r₂=(r₂ₓ, r_{2y}, r_{2z}) is a position vector of the acceleration sensor 2 as seen from the center of rotation O of the rigid body B, θ₂ is an angle formed between the vector r₂ and the z-axis (the axis corresponding to the angular acceleration component to be obtained), and φ₂ is an angle formed between the vector r₂ as seen along the z-axis (the vector r₂ projected onto the xy plane (the plane orthogonal to the z-axis) and the x-axis, the vector r₂ can be expressed as Formula (41).

$$[ Math . 41 ]$$

$${r}_{2} = \sqrt{{r}_{2 x}^{2} + {r}_{2 y}^{2} + {r}_{2 z}^{2}} , \\ {r}_{2 x} = {r}_{2} sin {θ}_{2} cos {ϕ}_{2} , \\ {r}_{2 y} = {r}_{2} sin {θ}_{2} sin {2}_{1} , \\ {r}_{2 z} = {r}_{2} cos {θ}_{2} , sin {θ}_{2} = \frac{\sqrt{{r}_{2 x}^{2} + {r}_{2 y}^{2}}}{\sqrt{{r}_{2 x}^{2} + {r}_{2 y}^{2} + {r}_{2 z}^{2}}} , \\ cos {θ}_{2} = \frac{{r}_{2 z}}{\sqrt{{r}_{2 x}^{2} + {r}_{2 y}^{2} + {r}_{2 z}^{2}}} , \\ sin {ϕ}_{2} = \frac{{r}_{2 y}}{\sqrt{{r}_{2 x}^{2} + {r}_{2 y}^{2}}} , \\ cos {ϕ}_{2} = \frac{{r}_{2 y}}{\sqrt{{r}_{2 x}^{2} + {r}_{2 y}^{2}}} \qquad ( 41 )$$

In addition, when h=(hₓ, h_{y}, h_{z}) is a position vector of the acceleration sensor 2 as seen from the acceleration sensor 1, the position vector h can be expressed as Formula (42) and therefore Formula (43).

$$[ Math . 42 ]$$

$$h = {r}_{2} - {r}_{1} \qquad ( 42 )$$

$$[ Math . 43 ]$$

$$( \begin{matrix}{h}_{x} \\ {h}_{y} \\ {h}_{z}\end{matrix} ) = ( \begin{matrix}{r}_{2 x} - {r}_{1 x} \\ {r}_{2 y} - {r}_{1 y} \\ {r}_{2 z} - {r}_{1 z}\end{matrix} ) \qquad ( 43 )$$

Then, when θ₃ is an angle formed between the vector h and the z-axis (the axis corresponding to the angular acceleration component to be obtained) and φ₃ is an angle formed between the vector h as seen along the z-axis (the vector h projected onto the xy plane (the plane orthogonal to the z-axis) and the x-axis, the vector h can be expressed as Formula (44).

$$[ Math . 44 ]$$

$$h = \sqrt{{h}_{x}^{2} + {h}_{y}^{2} + {h}_{z}^{2}} , \\ {h}_{x} = h sin {θ}_{3} cos {ϕ}_{3} , \\ {h}_{y} = h sin {θ}_{3} sin {ϕ}_{3} , \\ {h}_{z} = h cos {θ}_{3} sin {θ}_{3} = \frac{\sqrt{{h}_{x}^{2} + {h}_{y}^{2}}}{\sqrt{{h}_{x}^{2} + {h}_{y}^{2} + {h}_{z}^{2}}} , \\ cos {θ}_{3} = \frac{{h}_{z}}{\sqrt{{h}_{x}^{2} + {h}_{y}^{2} + {h}_{z}^{2}}} , \\ sin {ϕ}_{3} = \frac{{h}_{y}}{\sqrt{{h}_{x}^{2} + {h}_{y}^{2}}} , \\ sin {ϕ}_{3} = \frac{{h}_{x}}{\sqrt{{h}_{x}^{2} + {h}_{y}^{2}}} \qquad ( 44 )$$

Then, when the rigid body B is rotated about the z-axis by an angle φ from a predetermined position (where (h=(hₓ, h_{y}, h_{z})), the vector r₁=(r₁ₓ, r_{1y}, r_{1z}) and the vector r₂=(r₂ₓ, r_{2y}, r_{2z}) respectively move to vectors r1′ and r2′ in Formulae (45).

$$[ Math . 45 ]$$

$$vector {r}_{1}^{′} = ( \begin{matrix}cos φ & - sin φ & 0 \\ sin φ & cos φ & 0 \\ 0 & 0 & 1\end{matrix} ) ( \begin{matrix}{r}_{1 x} \\ {r}_{1 y} \\ {r}_{1 z}\end{matrix} ) = ( \begin{matrix}{r}_{1 x} cos φ - {r}_{1 y} sin φ \\ {r}_{1 x} sin φ - {r}_{1 y} cos φ \\ {r}_{1 z}\end{matrix} ) \\ vector {r}_{2}^{′} = ( \begin{matrix}cos φ & - sin φ & 0 \\ sin φ & cos φ & 0 \\ 0 & 0 & 1\end{matrix} ) ( \begin{matrix}{r}_{2 x} \\ {r}_{2 y} \\ {r}_{2 z}\end{matrix} ) = ( \begin{matrix}{r}_{2 x} cos φ - {r}_{2 y} sin φ \\ {r}_{2 x} sin φ - {r}_{2 y} cos φ \\ {r}_{2 z}\end{matrix} )$$

where the matrix

$$( \begin{matrix}cos φ & - sin φ & 0 \\ sin φ & cos φ & 0 \\ 0 & 0 & 1\end{matrix} )$$

is a rotation matrix about the z axis. (45)

Thus, when the rigid body B is rotated about the z-axis by the angle φ, the position of the acceleration sensor 1 moves from (r₁ₓ, r_{1y}, r_{1z}) to (r₁ₓ cos φ−r_{1y} sin φ, r₁ₓ sin φ+r_{1y} cos φ, r_{1z}), and the position of the acceleration sensor 2 moves from (r₂ₓ, r_{2y}, r_{2z}) to (r₂ₓ cos φ−r_{2y} sin φ, r₂ₓ sin φ+r_{2y} cos φ, r_{2z}). Then, r₂′−r₁′ is as expressed in Formula (46).

$$[ Math . 46 ]$$

$$\begin{matrix}( \begin{matrix}{r}_{2 x} - {r}_{1 x} \\ {r}_{2 y} - {r}_{1 y} \\ {r}_{2 z} - {r}_{1 z}\end{matrix} ) = ( \begin{matrix}{r}_{2 x} cos ϕ - {r}_{2 y} sin ϕ - ( {r}_{1 x} cos ϕ - {r}_{1 y} sin ϕ ) \\ {r}_{2 x} sin ϕ + {r}_{2 y} cos ϕ - ( {r}_{1 x} sin ϕ + {r}_{1 y} cos ϕ ) \\ {r}_{2 z} - {r}_{1 z}\end{matrix} ) \\ = ( \begin{matrix}( {r}_{2 x} - {r}_{1 x} ) cos ϕ - ( {r}_{2 y} - {r}_{1 y} ) sin ϕ \\ ( {r}_{2 x} - {r}_{1 x} ) sin ϕ + ( {r}_{2 y} - {r}_{1 y} ) cos ϕ \\ {r}_{2 z} - {r}_{1 z}\end{matrix} )\end{matrix} \qquad ( 46 )$$

Here, r₂ₓ−r₁ₓ=hₓ, r_{2y}−r_{1y}=h_{y}, and r_{2z}−r_{1z}=h_{z}. Then, r₂′−r₁′ is the position vector of the acceleration sensor 2 as seen from the acceleration sensor 1 after the rigid body B is rotated about the z-axis by the angle φ. Thus, when h′=r₂′−r₁′, the position vector h′ is as expressed in Formula (47).

$$[ Math . 47 ]$$

$$\begin{matrix}{h}^{′} = {r}_{2}^{′} - {r}_{1}^{′} = ( \begin{matrix}( {r}_{2 x} - {r}_{1 x} ) cos ϕ - ( {r}_{2 y} - {r}_{1 y} ) sin ϕ \\ ( {r}_{2 x} - {r}_{1 x} ) sin ϕ + ( {r}_{2 y} - {r}_{1 y} ) cos ϕ \\ {r}_{2 z} - {r}_{1 z}\end{matrix} ) = ( \begin{matrix}{h}_{x} cos ϕ - {h}_{y} sin ϕ \\ {h}_{x} sin ϕ + {h}_{y} cos ϕ \\ {h}_{z}\end{matrix} ) & ( 47 )\end{matrix}$$

Therefore, when the rigid body B is rotated about the z-axis by the angle φ, the position vector h=(hₓ, h_{y}, h_{z}) moves to a position vector h′=(hₓ cos φ−h_{y} sin φ, hₓ sin φ+h_{y} cos φ, h_{z}). Since sin φ and cos φ are as expressed in Formulae (48) as described earlier, the angle φ formed between the x-axis and the vector h as seen along the z-axis can be expressed with only the hₓ component and the h_{y} component without using the h_{z} component.

$$[ Math . 48 ]$$

$$sin ϕ = \frac{{r}_{y}}{\sqrt{{r}_{x}^{2} + {r}_{y}^{2}}} , \\ cos ϕ = \frac{{r}_{x}}{\sqrt{{r}_{x}^{2} + {r}_{y}^{2}}} . \qquad ( 48 )$$

As described, the position vector h=(hₓ, h_{y}, h_{z}) moves to the position vector h′=(hₓ cos φ−h_{y} sin φ, hₓ sin φ+h_{y} cos φ, h_{z}) when the rigid body B is rotated about the z-axis by the angle φ. Thus, it can be seen that when the rigid body B is rotated about the z-axis, the hₓ component and the h_{y} component which are differences respectively in the x-axis and y-axis directions between the two acceleration sensors 1 and 2 change, whereas the h_{z} component which is a difference in the z-axis direction between the two acceleration sensors 1 and 2 does not change. In other words, it can be seen that the angle φ by which the rigid body B is rotated about the z-axis is a value which is not dependent on the h_{z} component, which is the difference in the z-axis direction.

Then, when the rigid body B is rotated about the z-axis, the angle φ changes with time. Thus, an angle φ at a time t is φ=ω_{z}t, where ω_{z} is an angular velocity about the z-axis and the angle φ at a time t=0 is φ=0; therefore, the position vector h is as expressed in Formula (49).

$$[ Math . 49 ]$$

$$h = ( \begin{matrix}{h}_{x} cos {ω}_{z} t - {h}_{y} sin {ω}_{z} t \\ {h}_{x} sin {ω}_{z} t + {h}_{y} cos {ω}_{z} t \\ {h}_{z}\end{matrix} ) \qquad ( 49 )$$

This ω_{z}t is an angle ω which is not dependent on the h_{z} component, and since an angular velocity ω_{z} about the z-axis is the first time derivative of the angle φ, it can be seen that the h_{z} component, which is the difference in the z-axis direction, is a component which does not affect the change (temporal change) in the angle φ caused when the rigid body B is rotated about the z-axis. Then, the angular acceleration dω_{z}/dt about the z-axis is the first time derivative of the angular velocity ω_{z} about the z-axis and is the second time derivative of the angle φ. Hence, it can be seen that the h_{z} component, which is the difference in the z-axis direction, is a component which does not affect the change in the angular velocity ω_{z} (angular acceleration dω_{z}/dt) caused when the rigid body B is rotated about the z-axis, either. For these reasons, the angular acceleration dω_{z}/dt about the z-axis is a value not dependent on the h_{z} component, which is the difference in the z-axis direction between the two acceleration sensors 1, 2 (the first acceleration sensor 1 and the second acceleration sensor 2), and the angular acceleration dω_{z}/dt about the z-axis can also be expressed without using the h_{z} component.

Similarly for the y-axis, it can be seen that the angular acceleration dω_{y}/dt about the y-axis is a value not dependent on the h_{y} component, which is the difference in the y-axis direction between the two acceleration sensors 1, 2. Similarly for the x-axis, it can be seen that the angular acceleration dωₓ/dt about the x-axis is a value not dependent on the hₓ component, which is the difference in the x-axis direction between the two acceleration sensors 1, 2.

Thus, in order to consider the rotation about each axis of the rectangular coordinate system fixed to the rigid body B, there is no need to consider a component in the rotational axis direction.

### 10.2 How to Obtain Angular Acceleration Using Two Acceleration Sensors

Next, under the preconditions described in 10.1 above, a description is given on how to obtain angular acceleration using the two acceleration sensors 1, 2.

First, the position vector of the acceleration sensor 1 as seen from the center of rotation O of the rigid body B can be, as described earlier, expressed as Formula (50). Also, the position vector of the acceleration sensor 2 as seen from the center of rotation O of the rigid body B can be expressed as Formula (51). Further, the position vector of the acceleration sensor 2 as seen from the acceleration sensor 1 can be expressed as Formula (52).

$$[ Math . 50 ]$$

$${r}_{1} = ( \begin{matrix}{r}_{1 x} \\ {r}_{1 y} \\ {r}_{1 z}\end{matrix} ) \qquad ( 50 )$$

$$[ Math . 51 ]$$

$${r}_{2} = ( \begin{matrix}{r}_{2 x} \\ {r}_{2 y} \\ {r}_{2 z}\end{matrix} ) \qquad ( 51 )$$

$$[ Math . 52 ]$$

$$h = ( \begin{matrix}{h}_{x} \\ {h}_{y} \\ {h}_{z}\end{matrix} ) \qquad ( 52 )$$

Formula (53) is an acceleration vector obtained by the acceleration sensor 1, and Formula (54) is an acceleration vector obtained by the acceleration sensor 2. Then, Formula (55) is the difference between the acceleration vector a₂ and the acceleration vector a₁.

$$[ Math . 53 ]$$

$${a}_{1} = ( \begin{matrix}{a}_{1 x} \\ {a}_{1 y} \\ {a}_{1 z}\end{matrix} ) \qquad ( 53 )$$

$$[ Math . 54 ]$$

$${a}_{2} = ( \begin{matrix}{a}_{2 x} \\ {a}_{2 y} \\ {a}_{2 z}\end{matrix} ) \qquad ( 54 )$$

$$[ Math . 55 ]$$

$$u = ( \begin{matrix}{u}_{1} \\ {u}_{2} \\ {u}_{3}\end{matrix} ) \qquad ( 55 )$$

Specifically, the difference between the acceleration vector a₂ and the acceleration vector a₁ is expressed as Formula (56) and therefore Formula (57).

$$[ Math . 56 ]$$

$$u = {a}_{2} - {a}_{1} \qquad ( 56 )$$

$$[ Math . 57 ]$$

$$( \begin{matrix}{u}_{1} \\ {u}_{2} \\ {u}_{3}\end{matrix} ) = ( \begin{matrix}{a}_{2 x} - {a}_{1 x} \\ {a}_{2 y} - {a}_{1 y} \\ {a}_{2 z} - {a}_{1 z}\end{matrix} ) \qquad ( 57 )$$

Also, Formula (58) is an angular velocity vector obtained by the gyroscopic sensor 3, and Formula (59) is a gravitational acceleration exerted on the rigid body B as seen from the rigid body B. Then, the acceleration vectors obtained by the respective acceleration sensors 1, 2 (the acceleration vector al and the acceleration vector a₂) are as expressed in Formulae (8) and (9) and therefore in Formulae (10) to (14).

$$[ Math . 58 ]$$

$$ω = ( \begin{matrix}{ω}_{x} \\ {ω}_{y} \\ {ω}_{z}\end{matrix} ) \qquad ( 58 )$$

$$[ Math . 59 ]$$

$$g = ( \begin{matrix}{g}_{x} \\ {g}_{y} \\ {g}_{z}\end{matrix} ) \qquad ( 59 )$$

Based on Formula (12), Formula (60) holds true.

$$[ Math . 60 ]$$

$$x = Ω h = ( \begin{matrix}0 & - {ω}_{z} & {ω}_{y} \\ {ω}_{z} & 0 & - {ω}_{x} \\ - {ω}_{y} & {ω}_{x} & 0\end{matrix} ) ( \begin{matrix}{h}_{x} \\ {h}_{y} \\ {h}_{z}\end{matrix} ) = ( \begin{matrix}- {h}_{y} {ω}_{z} + {h}_{z} {ω}_{y} \\ {h}_{x} {ω}_{z} - {h}_{z} {ω}_{x} \\ - {h}_{x} {ω}_{y} + {h}_{y} {ω}_{x}\end{matrix} ) \qquad ( 60 )$$

Therefore, Formula (61) holds true.

$$[ Math . 61 ]$$

$$\dot{x} = \dot{Ω} h = ( \begin{matrix}0 & - {\dot{ω}}_{z} & {\dot{ω}}_{y} \\ {\dot{ω}}_{z} & 0 & - {\dot{ω}}_{x} \\ - {\dot{ω}}_{y} & {\dot{ω}}_{x} & 0\end{matrix} ) ( \begin{matrix}{h}_{x} \\ {h}_{y} \\ {h}_{z}\end{matrix} ) = ( \begin{matrix}- {h}_{y} {\dot{ω}}_{z} + {h}_{z} {\dot{ω}}_{y} \\ {h}_{x} {\dot{ω}}_{z} - {h}_{z} {\dot{ω}}_{x} \\ - {h}_{x} {\dot{ω}}_{y} + {h}_{y} {\dot{ω}}_{x}\end{matrix} ) \qquad ( 61 )$$

Also, Formula (62) holds true.

$$[ Math . 62 ]$$

$$\begin{matrix}- {Ω}_{x} = ( \begin{matrix}0 & {ω}_{z} & - {ω}_{y} \\ - {ω}_{z} & 0 & {ω}_{x} \\ {ω}_{y} & - {ω}_{x} & 0\end{matrix} ) ( \begin{matrix}- {h}_{y} {ω}_{z} + {h}_{z} {ω}_{y} \\ {h}_{x} {ω}_{z} - {h}_{z} {ω}_{x} \\ - {h}_{x} {ω}_{y} + {h}_{y} {ω}_{x}\end{matrix} ) \\ = ( \begin{matrix}( {ω}_{y}^{2} + {ω}_{z}^{2} ) {h}_{x} - {ω}_{x} {ω}_{y} {h}_{y} - {ω}_{z} {ω}_{x} {h}_{z} \\ - {ω}_{x} {ω}_{y} {h}_{x} + ( {ω}_{z}^{2} + {ω}_{x}^{2} ) {h}_{y} - {ω}_{y} {ω}_{z} {h}_{z} \\ - {ω}_{z} {ω}_{x} {h}_{x} - {ω}_{y} {ω}_{z} {h}_{y} + ( {ω}_{x}^{2} + {ω}_{y}^{2} ) {h}_{z}\end{matrix} ) \\ = ( \begin{matrix}( {ω}_{y}^{2} + {ω}_{z}^{2} ) & - {ω}_{x} {ω}_{y} & - {ω}_{z} {ω}_{x} \\ - {ω}_{x} {ω}_{y} & ( {ω}_{z}^{2} + {ω}_{x}^{2} ) & - {ω}_{y} {ω}_{z} \\ - {ω}_{z} {ω}_{x} & - {ω}_{y} {ω}_{z} & ( {ω}_{x}^{2} + {ω}_{y}^{2} )\end{matrix} ) ( \begin{matrix}{h}_{x} \\ {h}_{y} \\ {h}_{z}\end{matrix} )\end{matrix} \qquad ( 62 )$$

Then, when Formula (63) holds true, Formula (64) holds true.

$$\begin{matrix}[ Math . 63 ] & \\ ( \begin{matrix}( {ω}_{y}^{2} + {ω}_{z}^{2} ) & - {ω}_{x} {ω}_{y} & - {ω}_{z} {ω}_{x} \\ - {ω}_{x} {ω}_{y} & ( {ω}_{z}^{2} + {ω}_{x}^{2} ) & - {ω}_{y} {ω}_{z} \\ - {ω}_{z} {ω}_{x} & - {ω}_{y} {ω}_{z} & ( {ω}_{x}^{2} + {ω}_{y}^{2} )\end{matrix} ) = {Ω}_{1} & ( 63 ) \\ [ Math . 64 ] & \\ - Ω x = {Ω}_{1} h & ( 64 )\end{matrix}$$

Since Formula (65) holds true, Formula (66) holds true.

[Math. 65]

x=Ωh=ω×h=−h×ω (65)

[Math. 66]

\dot{x}=−h×\dot{ω} (66)

Since the matrix of cross products of the vector h is as expressed in Formula (67), Formula (69) holds true where an angular acceleration vector dω/dt is as expressed in Formula (68).

$$\begin{matrix}[ Math . 67 ] & \\ H = ( \begin{matrix}0 & - {h}_{z} & {h}_{y} \\ {h}_{z} & 0 & - {h}_{x} \\ - {h}_{y} & {h}_{x} & 0\end{matrix} ) & ( 67 ) \\ [ Math . 68 ] & \\ \dot{ω} = ( \begin{matrix}{\dot{ω}}_{x} \\ {\dot{ω}}_{y} \\ {\dot{ω}}_{z}\end{matrix} ) & ( 68 ) \\ [ Math . 69 ] & \\ \begin{matrix}\dot{x} = - h \times \dot{ω} \\ = - H \dot{ω} \\ = ( \begin{matrix}0 & {h}_{z} & - {h}_{y} \\ - {h}_{z} & 0 & {h}_{x} \\ {h}_{y} & - {h}_{x} & 0\end{matrix} ) ( \begin{matrix}{\dot{ω}}_{x} \\ {\dot{ω}}_{y} \\ {\dot{ω}}_{z}\end{matrix} )\end{matrix} & ( 69 )\end{matrix}$$

Therefore, Formula (70) can be expressed as Formula (71) and therefore Formula (72).

$$\begin{matrix} [ Math . 70 ] & \\ \dot{x} = - Ω x + u & ( 70 ) \\ [ Math . 71 ] & \\ - H \dot{ω} = {Ω}_{1} h + Iu \\ using the vector u = ( \begin{matrix}{u}_{1} \\ {u}_{2} \\ {u}_{3}\end{matrix} ) and the identity matrix I = ( \begin{matrix}1 & 0 & 0 \\ 0 & 1 & 0 \\ 0 & 0 & 1\end{matrix} ) & ( 71 ) \\ [ Math . 72 ] & \\ ( \begin{matrix}0 & {h}_{z} & - {h}_{y} \\ - {h}_{z} & 0 & {h}_{x} \\ {h}_{y} & - {h}_{x} & 0\end{matrix} ) ( \begin{matrix}{\dot{ω}}_{x} \\ {\dot{ω}}_{y} \\ {\dot{ω}}_{z}\end{matrix} ) = ( \begin{matrix}( {ω}_{y}^{2} + {ω}_{z}^{2} ) & - {ω}_{x} {ω}_{y} & - {ω}_{z} {ω}_{x} \\ - {ω}_{x} {ω}_{y} & ( {ω}_{z}^{2} + {ω}_{x}^{2} ) & - {ω}_{y} {ω}_{z} \\ - {ω}_{z} {ω}_{x} & - {ω}_{y} {ω}_{z} & ( {ω}_{x}^{2} + {ω}_{y}^{2} )\end{matrix} ) ( \begin{matrix}{h}_{x} \\ {h}_{y} \\ {h}_{z}\end{matrix} ) + ( \begin{matrix}1 & 0 & 0 \\ 0 & 1 & 0 \\ 0 & 0 & 1\end{matrix} ) ( \begin{matrix}{u}_{1} \\ {u}_{2} \\ {u}_{3}\end{matrix} ) & ( 72 )\end{matrix}$$

Thus, Formula (73) holds true.

$$\begin{matrix} [ Math . 73 ] & \\ ( \begin{matrix}- {h}_{y} {\dot{ω}}_{z} + {h}_{z} {\dot{ω}}_{y} \\ {h}_{x} {\dot{ω}}_{z} - {h}_{z} {\dot{ω}}_{x} \\ - {h}_{x} {\dot{ω}}_{y} + {h}_{y} {\dot{ω}}_{x}\end{matrix} ) = ( \begin{matrix}( {ω}_{y}^{2} + {ω}_{z}^{2} ) {h}_{x} - {ω}_{x} {ω}_{y} {h}_{y} - {ω}_{z} {ω}_{x} {h}_{z} + {u}_{1} \\ - {ω}_{x} {ω}_{y} {h}_{x} + ( {ω}_{z}^{2} + {ω}_{x}^{2} ) {h}_{y} - {ω}_{y} {ω}_{z} {h}_{z} + {u}_{2} \\ - {ω}_{z} {ω}_{x} {h}_{x} - {ω}_{y} {ω}_{z} {h}_{y} + ( {ω}_{x}^{2} + {ω}_{y}^{2} ) {h}_{z} + {u}_{3}\end{matrix} ) & ( 73 )\end{matrix}$$

Dividing them for each component yields Formulae (74).

[Math. 74]

1 0+h_{z}\dot{ω}_{y}+(−h_{y})\dot{ω}_{z}=hₓω_{z}²+(−h_{z}ωₓ)ω_{z}+hₓω_{y}²+(−h_{y})ωₓω_{y}+u1

2 −h_{z}\dot{ω}ₓ+0+hₓ\dot{ω}_{z}=h_{y}ω_{z}²+(−h_{z}ω_{y})ω_{z}+h_{y}ωₓ²+(−hₓ)ωₓω_{y}+u2

3 h_{y}\dot{ω}ₓ+(−hₓ)\dot{ω}_{y}+0=−(hₓωₓ+h_{y}ω_{y})ω_{z}+h_{z}(ωₓ²+ω_{y}²)+u3 (74)

### 10.3 How to Obtain the Angular Acceleration dω_{z}/dt about the Z-Axis

The angular acceleration dω_{z}/dt about the z-axis can be obtained as follows using 1 to 3 in Formulae (74).

First, as described earlier, the h_{z} component, which is the difference in the z-axis direction between the two acceleration sensors 1, 2, is a component that does not contribute to the angular acceleration dω_{z}/dt about the z-axis. Thus, the angular acceleration dω_{z}/dt about the z-axis where h=(hₓ, h_{y}, h_{z}) can be derived by obtaining the angular acceleration dω_{z}/dt about the z-axis where h=(hₓ, h_{y}, 0). To this end, the angular acceleration dω_{z}/dt about the z-axis where h=(hₓ, h_{y}, 0) is now obtained. Specifically, 0 (zero) is substituted into h_{z} in 1 to 3 in Formulae (74). Then, 1 to 3 in Formulae (74) become 1′ to 3′ in Formulae (75), respectively.

[Math. 75]

1′ −h_{y}\dot{ω}_{z}=hₓω_{z}²+hₓω_{y}²+(−h_{y})ωₓω_{y}+u1

2′ hₓ\dot{ω}_{z}=h_{y}ω_{z}²+h_{y}ωₓ²+(−hₓ)ωₓω_{y}+u2

3′ h_{y}\dot{ω}ₓ+(−hₓ)\dot{ω}_{y}=−(hₓωₓ+h_{y}ω_{y})ω_{z}+u3 (75)

Then, calculating 2′×hₓ−1′×h_{y} and canceling ω_{z}² yields Formula (76).

[Math. 76]

(hₓ²+h_{y}²)\dot{ω}_{z}=hₓh_{y}(ωₓ²−ω_{y}²)+(h_{y}²−hₓ²)ωₓω_{y}+hₓu₂−h_{y}u₁ (76)

Thus, Formula (77) holds true.

$$\begin{matrix}[ Math . 77 ] & \\ {\dot{ω}}_{z} = \frac{{h}_{x} {u}_{2} - {h}_{y} {u}_{1}}{{h}_{x}^{2} + {h}_{y}^{2}} + \frac{( {h}_{y}^{2} - {h}_{x}^{2} ) {ω}_{x} {ω}_{y} + {h}_{x} {h}_{y} ( {ω}_{x}^{2} - {ω}_{y}^{2} )}{{h}_{x}^{2} + {h}_{y}^{2}} & ( 77 )\end{matrix}$$

Based on the above, the angular acceleration dω_{z}/dt about the z-axis obtained with the two acceleration sensors 1, 2 disposed away from each other in an xyz space such that h=(hₓ, h_{y}, h_{z}) holds can be expressed as Formula (78).

$$\begin{matrix}[ Math . 78 ] & \\ {\dot{ω}}_{z} = \frac{{h}_{x} {u}_{2} - {h}_{y} {u}_{1}}{{h}_{x}^{2} + {h}_{y}^{2}} + \frac{( {h}_{y}^{2} - {h}_{x}^{2} ) {ω}_{x} {ω}_{y} + {h}_{x} {h}_{y} ( {ω}_{x}^{2} - {ω}_{y}^{2} )}{{h}_{x}^{2} + {h}_{y}^{2}} & ( 78 )\end{matrix}$$

Here, when h=(0, 0, h_{z}), substituting h=(0, 0, h_{z}) into 1 to 3 in Formula (74) results in Formulae (79), which means that the angular acceleration dω_{z}/dt about the z-axis cannot be obtained using the two acceleration sensors 1, 2.

[Math. 79]

1 h_{z}\dot{ω}_{y}=−h_{z}ωₓω_{z}+u₁

2 (−h_{z})\dot{ω}ₓ=−h_{z}ω_{y}ω_{z}+u₂

3 0=h_{z}(ωₓ²+ω_{y}²)+u₃ (79)

Note that when h=(0, 0, h_{z}), the denominator (hₓ²+h_{y}²) in Formula (78) is 0 (zero), and from this as well, it can be seen that when h=(0, 0, h_{z}), the angular acceleration dω_{z}/dt about the z-axis cannot be obtained using the two acceleration sensors 1, 2. It can thus be seen from Formula (78) that when the acceleration sensor 2 is away from the acceleration sensor 1 only in the z-direction, the angular acceleration dω_{z}/dt about the z-axis cannot be obtained with the two acceleration sensors 1, 2. It can also be seen from Formula (78) that in a case where the two acceleration sensors 1, 2 are disposed away from each other in the xyz space (where h=(hₓ, h_{y}, h_{z})), including a case where they are disposed away from each other on the xy plane (where h=(hₓ, h_{y}, 0)), the angular acceleration dω_{z}/dt about the z-axis can be obtained using the angular velocity ωₓ about the x-axis and the angular velocity ω_{y} about the y-axis which are obtained by the gyroscopic sensor 3 and an x-direction component of acceleration and a y-direction component of acceleration which are obtained by the two acceleration sensors 1, 2.

When h=(hₓ, 0, 0), b_{y}=0 and h_{z}=0; hence, Formula (80) and therefore Formula (81) hold true.

$$\begin{matrix}[ Math . 80 ] & \\ {\dot{ω}}_{z} = \frac{{h}_{x} {u}_{2}}{{h}_{x}^{2}} + \frac{- {h}_{x}^{2} {ω}_{x} {ω}_{y}}{{h}_{x}^{2}} & ( 80 ) \\ [ Math . 81 ] & \\ {\dot{ω}}_{z} = \frac{{u}_{2}}{{h}_{x}} - {ω}_{x} {ω}_{y} & ( 81 )\end{matrix}$$

It can be seen from this formula that when the two acceleration sensors 1, 2 are disposed away from each other in the x-direction (when h=(hₓ, 0, 0)), the angular acceleration dω_{z}/dt about the z-axis is obtained using a y-direction component of acceleration. Note that this formula can be obtained by substituting h=(hₓ, 0, 0) into 1 to 3 in Formulae (74).

When h=(0, h_{y}, 0), hₓ=0 and h_{z}=0; hence, Formula (82) and therefore Formula (83) hold true.

$$\begin{matrix}[ Math . 82 ] & \\ {\dot{ω}}_{z} = \frac{- {h}_{y} {u}_{1}}{{h}_{y}^{2}} + \frac{{h}_{y}^{2} {ω}_{x} {ω}_{y}}{{h}_{y}^{2}} & ( 82 ) \\ [ Math . 83 ] & \\ {\dot{ω}}_{z} = \frac{- {u}_{1}}{{h}_{y}} + {ω}_{x} {ω}_{y} & ( 83 )\end{matrix}$$

It can be seen from this formula that when the two acceleration sensors 1, 2 are disposed away from each other in the y-direction (when h=(0, h_{y}, 0)), the angular acceleration dω_{z}/dt about the z-axis is obtained using an x-direction component of acceleration. Note that this formula can be obtained by substituting h=(0, h_{y}, 0) into 1 to 3 in Formula (74).

It can be seen from the above that in order to obtain the angular acceleration dω_{z}/dt about the z-axis using the two acceleration sensors 1, 2, it is necessary to dispose the acceleration sensor 2 at a position away from the acceleration sensor 1 not only in the z-direction. Specifically, it can be seen that the acceleration sensor 2 needs to be disposed such that the position vector h as seen from the acceleration sensor 1 does not coincide with a straight line that extends in the z-axis direction while passing through the acceleration sensor 1. In other words, it can be seen that the acceleration sensor 2 needs to be disposed such that the position vector h as seen from the acceleration sensor 1 intersects with the straight line that extends in the z-axis direction while passing through the acceleration sensor 1.

It can also be seen that the acceleration sensor 2 disposed relative to the acceleration sensor 1 in the above manner needs to be enabled to detect acceleration in a direction which is orthogonal to the z-axis and orthogonal to a projected vector which is the vector h projected onto the xy plane (the plane orthogonal to the z-axis). It can be seen from this that when the acceleration sensor 2 is disposed at a position away from the acceleration sensor 1 not only in the x-direction or not only in the y-direction, the acceleration sensor 2 needs to be enabled to detect an x-direction component of acceleration and a y-direction component of acceleration.

Usually, the fact that the acceleration sensor 2 needs to be enabled to detect an x-direction component of acceleration and a y-direction component of acceleration may be understood from the above formulae.

To be enabled to detect an x-direction component of acceleration and a y-direction component of acceleration, the acceleration sensor 2 is desirably one capable of detecting acceleration along three or more axes. Thus, when the acceleration sensor 2 capable of detecting acceleration along three or more axes is used, an x-direction component of acceleration and a y-direction component of acceleration can be obtained from the detected acceleration, irrespective of how the acceleration sensor 2 is disposed.

Even if the acceleration sensor 2 is one capable of detecting acceleration along two axes, the angular acceleration dω_{z}/dt about the z-axis can be obtained as long as the acceleration sensor 2 is disposed to be able to detect an x-direction component of acceleration and a y-direction component of acceleration. However, if the directions of the two detection axes of the acceleration sensor 2 both extend along the xz plane or along the yz plane, the acceleration sensor 2 cannot detect an x-direction component of acceleration and a y-direction component of acceleration.

Also, even if the acceleration sensor 2 is capable of detecting acceleration along only one axis, the angular acceleration dω_{z}/dt about the z-axis can be obtained as long as the acceleration sensor 2 is disposed to be able to break down the detected acceleration into an x-direction component of acceleration and a y-direction component of acceleration. However, when the direction of the detection axis of the acceleration sensor 2 extends along the z-axis, the acceleration sensor 2 cannot detect an x-direction component of acceleration and a y-direction component of acceleration. Even in a case where the direction of the detection axis of the acceleration sensor 2 does not extend along the z-axis, if the direction of the detection axis of the acceleration sensor 2 extends along the xz plane or along the yz plane, the acceleration sensor 2 cannot detect an x-direction component of acceleration and a y-direction component of acceleration unless the conditions to be described later are satisfied.

In this way, usually, the acceleration sensor 2 needs to be disposed to be able to detect both of an x-direction component of acceleration and a y-direction component of acceleration.

However, when the acceleration sensor 2 is away from the acceleration sensor 1 only in the x-direction, the angular acceleration dω_{z}/dt about the z-axis can be obtained by detection of only a y-direction component of acceleration. More specifically, when the acceleration sensor 2 is away from the acceleration sensor 1 only in the x-direction, the angular acceleration dω_{z}/dt about the z-axis can be obtained as long as the direction of the detection axis of the acceleration sensor 2 intersects with the z-axis even though extending along the yz plane. It is preferable from the perspective of improving detection accuracy that the direction of the detection axis of the acceleration sensor 2 extend along the y-axis direction.

Also, when the acceleration sensor 2 is away from the acceleration sensor 1 only in the y-direction, the angular acceleration dω_{z}/dt about the z-axis can be obtained by detection of only an x-direction component of acceleration. Thus, when the acceleration sensor 2 is away from the acceleration sensor 1 only in the y-direction, the angular acceleration dω_{z}/dt about the z-axis can be obtained as long as the direction of the detection axis of the acceleration sensor 2 intersects with the z-axis even though extending along the xz plane. It is preferable from the perspective of improving detection accuracy that the direction of the detection axis of the acceleration sensor 2 extend along the x-axis direction.

When the acceleration sensor 2 is thus away from the acceleration sensor 1 only in the direction of one axis (only in the x-direction or only in the y-direction), the angular acceleration dω_{z}/dt about the z-axis can be obtained even when the acceleration sensor 2 that detects only one axis is used and when the direction of the axis of acceleration detected by the acceleration sensor 2 coincides with the y-direction or the x-direction.

### 10.4 How to Obtain the Angular Acceleration dω_{y}/dt about the Y-axis

Similarly, the angular acceleration dω_{y}/dt about the y-axis where h=(hₓ, h_{y}, h_{z}) can be derived by obtaining the angular acceleration dω_{y}/dt about the y-axis where h=(hₓ, 0, h_{z}).

Specifically, the angular acceleration dω_{y}/dt about the y-axis is as expressed in Formula (84). This formula can be obtained by substituting h=(hₓ, 0, h_{z}) into 1 to 3 in Formulae (74).

$$\begin{matrix}[ Math . 84 ] & \\ {\dot{ω}}_{y} = \frac{{h}_{z} {u}_{1} - {h}_{x} {u}_{3}}{{h}_{z}^{2} + {h}_{x}^{2}} - \frac{( {h}_{z}^{2} - {h}_{x}^{2} ) {ω}_{z} {ω}_{x} + {h}_{z} {h}_{x} ( {ω}_{z}^{2} - {ω}_{x}^{2} )}{{h}_{z}^{2} + {h}_{x}^{2}} & ( 84 )\end{matrix}$$

Note that when h=(0, h_{y}, 0), the denominator (h_{z}²+hₓ²) in Formula (84) is 0 (zero); thus, it can be seen that when h=(0, h_{y}, 0), the angular acceleration dω_{y}/dt about the y-axis cannot be obtained using the two acceleration sensors 1, 2. It can thus be seen from Formula (84) that when the acceleration sensor 2 is away from the acceleration sensor 1 only in the y-direction, the angular acceleration dω_{y}/dt about the y-axis cannot be obtained. It can also be seen from Formula (84) that in a case where the two acceleration sensors 1, 2 are disposed away from each other in the xyz space (where (h=(hₓ, h_{y}, h_{z})), including a case where they are disposed away from each other on the xz plane (where h=(hₓ, 0, h_{z})), the angular acceleration dω_{y}/dt about the y-axis can be obtained using the angular velocity ωₓ about the x-axis and the angular velocity ω_{z} about the z-axis which are obtained by the gyroscopic sensor 3 and an x-direction component of acceleration and a z-direction component of acceleration which are obtained by the two acceleration sensors 1, 2.

When h=(hₓ, 0, 0), h_{y}=0 and h_{z}=0; hence, Formula (85) and therefore Formula (86) hold true.

$$\begin{matrix}[ Math . 85 ] & \\ {\dot{ω}}_{y} = \frac{- {h}_{x} {u}_{3}}{{h}_{x}^{2}} - \frac{- {h}_{x}^{2} {ω}_{z} {ω}_{x}}{{h}_{x}^{2}} & ( 85 ) \\ [ Math . 86 ] & \\ {\dot{ω}}_{y} = \frac{- {u}_{3}}{{h}_{x}} + {ω}_{z} {ω}_{x} & ( 86 )\end{matrix}$$

It can be seen from this formula that when the two acceleration sensors 1, 2 are disposed away from each other in the x-direction (when h=(hₓ, 0, 0)), the angular acceleration dω_{y}/dt about the y-axis is obtained using a z-direction component of acceleration. Note that this formula can be obtained by substituting h=(hₓ, 0, 0) into 1 to 3 in Formulae (74).

When h=(0, 0, h_{z}), hₓ=0 and b_{y}=0; hence, Formula (87) and therefore Formula (88) hold true.

$$\begin{matrix}[ Math . 87 ] & \\ {\dot{ω}}_{y} = \frac{{h}_{z} {u}_{1}}{{h}_{z}^{2}} - \frac{{h}_{z}^{2} {ω}_{z} {ω}_{x}}{{h}_{z}^{2}} & ( 87 ) \\ [ Math . 88 ] & \\ {\dot{ω}}_{y} = \frac{{u}_{1}}{{h}_{z}} - {ω}_{z} {ω}_{x} & ( 88 )\end{matrix}$$

It can be seen from this formula that when the two acceleration sensors 1, 2 are disposed away from each other in the z-direction (when h=(0, 0, h_{z})), the angular acceleration dω_{y}/dt about the y-axis is obtained using an x-direction component of acceleration. Note that this formula can be obtained by substituting h=(0, 0, h_{z}) into 1 to 3 in Formulae (74).

It can be seen from the above that in order to obtain the angular acceleration dω_{y}/dt about the y-axis using the two acceleration sensors 1, 2, it is necessary to dispose the acceleration sensor 2 at a position away from the acceleration sensor 1 not only in the y-direction. Specifically, it can be seen that the acceleration sensor 2 needs to be disposed such that the position vector h as seen from the acceleration sensor 1 does not coincide with a straight line that extends in the y-axis direction while passing through the acceleration sensor 1. In other words, it can be seen that the acceleration sensor 2 needs to be disposed such that the position vector h as seen from the acceleration sensor 1 intersects with the straight line that extends in the y-axis direction while passing through the acceleration sensor 1.

It can also be seen that the acceleration sensor 2 disposed relative to the acceleration sensor 1 in the above manner needs to be enabled to detect acceleration in a direction which is orthogonal to the y-axis and orthogonal to a projected vector which is the vector h projected onto the xz plane (the plane orthogonal to the y-axis). It can be seen from this that when the acceleration sensor 2 is disposed at a position away from the acceleration sensor 1 not only in the x-direction or not only in the z-direction, the acceleration sensor 2 needs to be enabled to detect an x-direction component of acceleration and a z-direction component of acceleration.

Usually, the fact that the acceleration sensor 2 needs to be enabled to detect an x-direction component of acceleration and a z-direction component of acceleration is understood from the above formulae.

To be enabled to detect an x-direction component of acceleration and a z-direction component of acceleration, the acceleration sensor 2 is desirably one capable of detecting acceleration along three or more axes. Thus, when the acceleration sensor 2 capable of detecting acceleration along three or more axes is used, an x-direction component of acceleration and a z-direction component of acceleration can be obtained from the detected acceleration, irrespective of how the acceleration sensor 2 is disposed.

Even if the acceleration sensor 2 is one capable of detecting acceleration along two axes, the angular acceleration dω_{y}/dt about the y-axis can be obtained as long as the acceleration sensor 2 is disposed to be able to detect an x-direction component of acceleration and a z-direction component of acceleration. However, if the directions of the two detection axes of the acceleration sensor 2 both extend along the xy plane or along the yz plane, the acceleration sensor 2 cannot detect an x-direction component of acceleration and a z-direction component of acceleration.

Also, even if the acceleration sensor 2 is one capable of detecting acceleration along only one axis, the angular acceleration dω_{y}/dt about the y-axis can be obtained as long as the acceleration sensor 2 is disposed to be able to break down the detected acceleration into an x-direction component of acceleration and a z-direction component of acceleration. However, when the direction of the detection axis of the acceleration sensor 2 extends along the y-axis, the acceleration sensor 2 cannot detect an x-direction component of acceleration and a z-direction component of acceleration. Even in a case where the direction of the detection axis of the acceleration sensor 2 does not extend along the y-axis but extends along the xy plane or along the yz plane, the acceleration sensor 2 cannot detect an x-direction component of acceleration and a z-direction component of acceleration unless the conditions to be described later are satisfied.

In this way, usually, the acceleration sensor 2 needs to be disposed to be able to detect both of an x-direction component of acceleration and a z-direction component of acceleration.

However, when the acceleration sensor 2 is away from the acceleration sensor 1 only in the x-direction, the angular acceleration dω_{y}/dt about the y-axis can be obtained by detection of only a z-direction component of acceleration. More specifically, when the acceleration sensor 2 is away from the acceleration sensor 1 only in the x-direction, the angular acceleration dω_{y}/dt about the y-axis can be obtained as long as the direction of the detection axis of the acceleration sensor 2 intersects with the y-axis even though extending along the yz plane. It is preferable from the perspective of improving detection accuracy that the direction of the detection axis of the acceleration sensor 2 extend along the z-axis direction.

Also, when the acceleration sensor 2 is away from the acceleration sensor 1 only in the z-direction, the angular acceleration dω_{y}/dt about the y-axis can be obtained by detection of only an x-direction component of acceleration. Thus, when the acceleration sensor 2 is away from the acceleration sensor 1 only in the z-direction, the angular acceleration dω_{y}/dt about the y-axis can be obtained as long as the direction of the detection axis of the acceleration sensor 2 intersects with the y-axis even though extending along the xy plane. It is preferable from the perspective of improving detection accuracy that the direction of the detection axis of the acceleration sensor 2 extend along the x-axis direction.

When the acceleration sensor 2 is thus away from the acceleration sensor 1 only in the direction of one axis (only in the x-direction or only in the z-direction), the angular acceleration dω_{y}/dt about the y-axis can be obtained even when the acceleration sensor 2 that detects only one axis is used and when the direction of the axis of acceleration detected by the acceleration sensor 2 coincides with the z-direction or the x-direction.

### 10.5 How to Obtain the Angular Acceleration dωₓ/dt about the X-axis

Similarly, the angular acceleration dωₓ/dt about the x-axis when h=(hₓ, h_{y}, h_{z}) can be derived by obtaining the angular acceleration dωₓ/dt about the x-axis when h=(0, h_{y}, h_{z}).

Specifically, the angular acceleration dωₓ/dt about the x-axis is as expressed in Formula (89). This formula can be obtained by substituting h=(0, h_{y}, h_{z}) into 1 to 3 in Formulae (74).

$$\begin{matrix}[ Math . 89 ] & \\ {\dot{ω}}_{x} = \frac{{h}_{y} {u}_{{3}^{-}} {h}_{z} {u}_{2}}{{h}_{y}^{2} + {h}_{z}^{2}} - \frac{( {h}_{y}^{2} - {h}_{z}^{2} ) {ω}_{y} {ω}_{z} + {h}_{y} {h}_{z} ( {ω}_{y}^{2} - {ω}_{z}^{2} )}{{h}_{y}^{2} + {h}_{z}^{2}} & ( 89 )\end{matrix}$$

Note that when h=(hₓ, 0, 0), the denominator (h_{y}²+h_{z}²) in Formula (89) is 0 (zero); thus, it can be seen that when h=(hₓ, 0, 0), the angular acceleration dωₓ/dt about the x-axis cannot be obtained using the two acceleration sensors 1, 2. It can thus be seen from Formula (89) that when the acceleration sensor 2 is away from the acceleration sensor 1 only in the x-direction, the angular acceleration dωₓ/dt about the x-axis cannot be obtained. It can also be seen from Formula (89) that in a case where the two acceleration sensors 1, 2 are disposed away from each other in the xyz space (where (h=(hₓ, h_{y}, h_{z})), including a case where they are disposed away from each other on the yz plane (where h=(0, h_{y}, h_{z})), the angular acceleration dωₓ/dt about the x-axis can be obtained using the angular velocity ω_{y} about the y-axis and the angular velocity ω_{z} about the z-axis which are obtained by the gyroscopic sensor 3 and a y-direction component of acceleration and a z-direction component of acceleration which are obtained by the two acceleration sensors 1, 2.

When h=(0, h_{y}, 0), hₓ32 0 and h_{z}=0; hence, Formula (90) and therefore Formula (91) hold true.

$$\begin{matrix}[ Math . 90 ] & \\ {\dot{ω}}_{x} = \frac{{h}_{y} {u}_{3}}{{h}_{y}^{2}} - \frac{{h}_{y}^{2} {ω}_{y} {ω}_{z}}{{h}_{y}^{2}} & ( 90 ) \\ [ Math . 91 ] & \\ {\dot{ω}}_{x} = \frac{{u}_{3}}{{h}_{y}} - {ω}_{y} {ω}_{z} & ( 91 )\end{matrix}$$

It can be seen from this formula that when the two acceleration sensors 1, 2 are disposed away from each other in the y-direction (when h=(0, h_{y}, 0)), the angular acceleration dωₓ/dt about the x-axis is obtained using a z-direction component of acceleration. Note that this formula can be obtained by substituting h=(0, h_{y}, 0) into 1 to 3 in Formulas (74).

When h=(0, 0, h_{z}), hₓ=0 and h_{y}=0; hence, Formula (92) and therefore Formula (93) hold true.

$$\begin{matrix}[ Math . 92 ] & \\ {\dot{ω}}_{x} = \frac{- {h}_{z} {u}_{2}}{{h}_{z}^{2}} - \frac{- {h}_{z}^{2} {ω}_{y} {ω}_{z}}{{h}_{z}^{2}} & ( 92 ) \\ [ Math . 93 ] & \\ {\dot{ω}}_{x} = \frac{- {u}_{2}}{{h}_{z}} + {ω}_{y} {ω}_{z} & ( 93 )\end{matrix}$$

It can be seen from this formula that when the two acceleration sensors 1, 2 are disposed away from each other in the z-direction (when h=(0, 0, h_{z})), the angular acceleration dωₓ/dt about the x-axis is obtained using a y-direction component of acceleration. Note that this formula can be obtained by substituting h=(0, 0, h_{z}) into 1 to 3 in Formulae (74).

It can be seen from the above that in order to obtain the angular acceleration dωₓ/dt about the x-axis using the two acceleration sensors 1, 2, it is necessary to dispose the acceleration sensor 2 at a position away from the acceleration sensor 1 not only in the x-direction. Specifically, it can be seen that the acceleration sensor 2 needs to be disposed such that the position vector h as seen from the acceleration sensor 1 does not coincide with a straight line that extends in the x-axis direction while passing through the acceleration sensor 1. In other words, it can be seen that the acceleration sensor 2 needs to be disposed such that the position vector h as seen from the acceleration sensor 1 intersects with the straight line that extends in the x-axis direction while passing through the acceleration sensor 1.

It can also be seen that the acceleration sensor 2 disposed relative to the acceleration sensor 1 in the above manner needs to be enabled to detect acceleration in a direction which is orthogonal to the x-axis and orthogonal to a projected vector which is the vector h projected onto the yz plane (the plane orthogonal to the x-axis). It can be seen from this that when the acceleration sensor 2 is away from the acceleration sensor 1 not only in the y-direction or not only in the z-direction, the acceleration sensor 2 needs to be enabled to detect a y-direction component of acceleration and a z-direction component of acceleration.

Usually, the fact that the acceleration sensor 2 needs to be enabled to detect a y-direction component of acceleration and a z-direction component of acceleration is understood from the above formulae.

To be enabled to detect a y-direction component of acceleration and a z-direction component of acceleration, the acceleration sensor 2 is desirably one capable of detecting acceleration along three or more axes. Thus, when the acceleration sensor 2 capable of detecting acceleration along three or more axes is used, a y-direction component of acceleration and a z-direction component of acceleration can be obtained from the detected acceleration, irrespective of how the acceleration sensor 2 is disposed.

Even if the acceleration sensor 2 is one capable of detecting acceleration along two axes, the angular acceleration dωₓ/dt about the x-axis can be obtained as long as the acceleration sensor 2 is disposed to be able to detect a y-direction component of acceleration and a z-direction component of acceleration. However, if the directions of the two detection axes of the acceleration sensor 2 both extend along the xy plane or along the xz plane, the acceleration sensor 2 cannot detect a y-direction component of acceleration and a z-direction component of acceleration.

Also, even if the acceleration sensor 2 is one capable of detecting acceleration along only one axis, the angular acceleration dωₓ/dt about the x-axis can be obtained as long as the acceleration sensor 2 is disposed to be able to break down the detected acceleration into a y-direction component of acceleration and a z-direction component of acceleration. However, when the direction of the detection axis of the acceleration sensor 2 extends along the x-axis, the acceleration sensor 2 cannot detect a y-direction component of acceleration and a z-direction component of acceleration. Even in a case where the direction of the detection axis of the acceleration sensor 2 does not extend along the x-axis, if the direction of the detection axis of the acceleration sensor 2 extends along the xy plane or along the xz plane, the acceleration sensor 2 cannot detect a y-direction component of acceleration and a z-direction component of acceleration unless the conditions to be described later are satisfied.

In this way, usually, the acceleration sensor 2 needs to be disposed to be able to detect both of a y-direction component of acceleration and a z-direction component of acceleration.

However, when the acceleration sensor 2 is away from the acceleration sensor 1 only in the y-direction, the angular acceleration dωₓ/dt about the x-axis can be obtained by detection of only a z-direction component of acceleration. More specifically, when the acceleration sensor 2 is away from the acceleration sensor 1 only in the y-direction, the angular acceleration dωₓ/dt about the x-axis can be obtained as long as the direction of the detection axis of the acceleration sensor 2 intersects with the x-axis even though extending along the xz plane. It is preferable from the perspective of improving detection accuracy that the direction of the detection axis of the acceleration sensor 2 extend along the z-axis direction.

Also, when the acceleration sensor 2 is away from the acceleration sensor 1 only in the z-direction, the angular acceleration dωₓ/dt about the x-axis can be obtained by detection of only a y-direction component of acceleration. Thus, when the acceleration sensor 2 is away from the acceleration sensor 1 only in the z-direction, the angular acceleration dωₓ/dt about the x-axis can be obtained as long as the direction of the detection axis of the acceleration sensor 2 intersects with the x-axis even though extending along the xy plane. It is preferable from the perspective of improving detection accuracy that the direction of the detection axis of the acceleration sensor 2 extend along the y-axis direction.

When the acceleration sensor 2 is thus away from the acceleration sensor 1 only in the direction of one axis (only in the y-direction or only in the z-direction), the angular acceleration dωₓ/dt about the x-axis can be obtained even when the acceleration sensor 2 that detects only one axis is used and when the direction of the axis of acceleration detected by the acceleration sensor 2 coincides with the z-direction or the y-direction.

### 11 Second Embodiment and Third Embodiment

As already described, generally, a point R in a space can be expressed as a vector r=(rₓ, r_{y}, r_{z}) as seen from a reference point such as the origin, as shown in FIG. 7. Since the angular acceleration dω_{z}/dt about the z-axis is a value not dependent on a h_{z} component, which is the difference in the z-axis direction between the two acceleration sensors 1, 2 (the first acceleration sensor 1 and the second acceleration sensor 2)), the angular acceleration dω_{z}/dt about the z-axis can be also expressed without using the h_{z} component. Similarly for the y-axis, the angular acceleration dω_{y}/dt about the y-axis is a value not dependent on a h_{y} component, which is the difference in the y-axis direction between the two acceleration sensors 1, 2. Similarly for the x-axis, the angular acceleration dωₓ/dt about the x-axis is a value not dependent on a hₓ component, which is the difference in the x-axis direction between the two acceleration sensors 1, 2. Thus, in order to consider the rotation about each axis of the rectangular coordinate system fixed to the rigid body B, there is no need to consider the component in the rotational axis.

The first embodiment corresponds to rotary motions with three degrees of freedom, i.e., rotary motions about the roll, pitch, and yaw axes. In a case of rotary motions with two degrees of freedom except for, for example, the rotary motion about the roll axis, i.e., the x-axis, only the rotary motions about the pitch axis and the yaw axis need to be detected. Thus, the composite sensor 10 can be formed of a total of five axes: a bi-axial angular velocity sensor for detecting the y-axis and the z-axis, a bi-axial acceleration sensor for detecting the x-axis and the z-axis, and a single-axis acceleration sensor for detecting the x-axis or the z-axis. With reference to the drawings, a description is given below on the composite sensor 10 and an angular velocity correction method according to this second embodiment. Note that throughout the drawings, the same or similar parts are denoted by the same or similar reference signs.

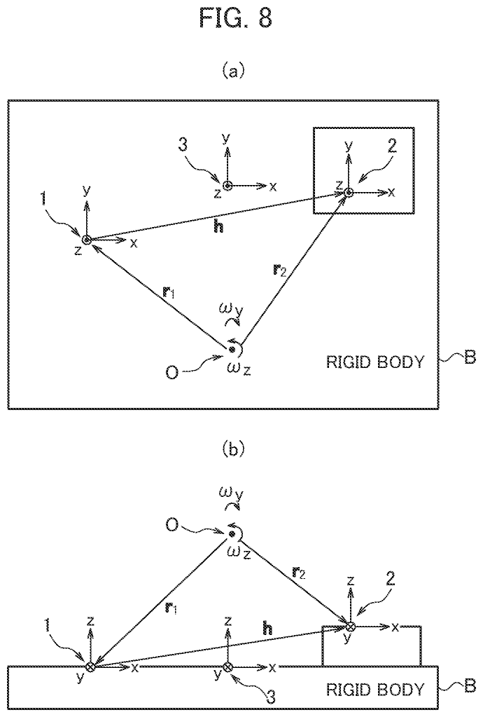

FIG. 8 is a diagram showing an example of how a bi-axial acceleration sensor 1, a single-axis acceleration sensor 2, and a bi-axial gyroscopic sensor 3 that the composite sensor 10 according to the second embodiment includes are arranged, part (a) being a plan view and part (b) being a side view. The acceleration sensor 1, the acceleration sensor 2, and the gyroscopic sensor 3 respectively correspond to the first acceleration sensor 1, the second acceleration sensor 2, and the angular velocity sensor 3 in FIG. 1 and are therefore described using the same reference signs.

In the second embodiment, as shown in FIG. 8, with the bi-axial acceleration sensor 1, the single-axis acceleration sensor 2, and the bi-axial gyroscopic sensor 3 being fixed to a rigid body B, theoretical values of their sensor outputs are calculated using vector analysis.

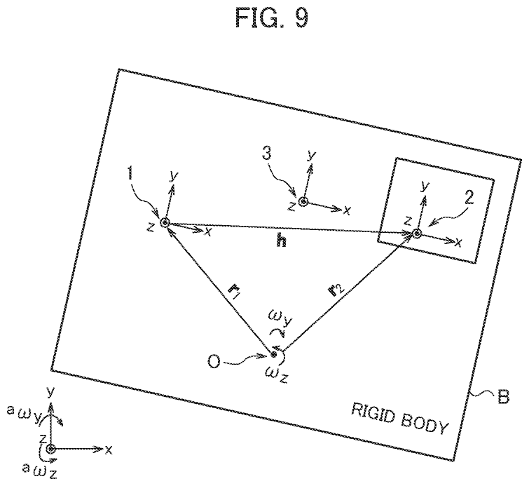

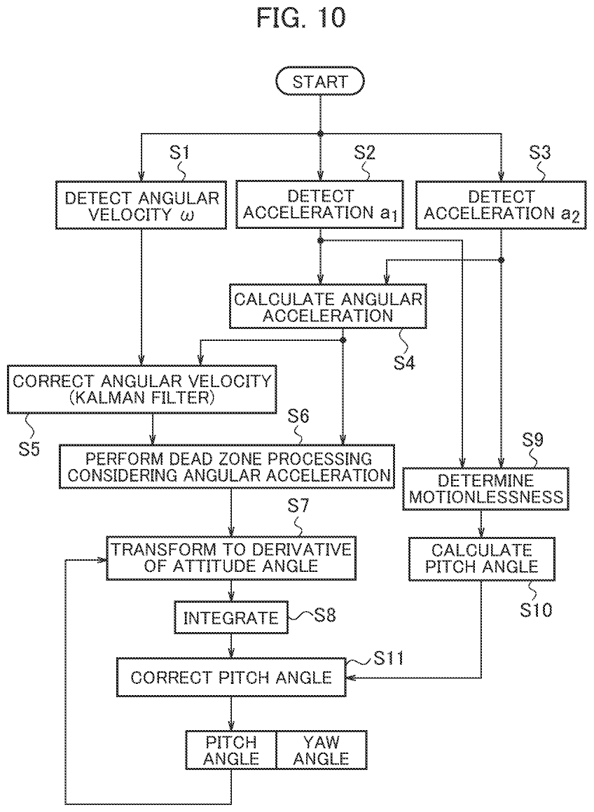

FIG. 9 is a diagram in which a stationary reference coordinate system ΣXYZ is added to FIG. 8 and represents the attitude (pitch and yaw angles) of the rigid body B as seen from the stationary reference coordinate system ΣXYZ. FIG. 10 is a flowchart showing the operation of the composite sensor 10 according to the second embodiment. With reference to FIG. 10, a description is given below on an operation for obtaining an attitude angle using the above-described method. Note that the steps same as or similar to those in the first embodiment are denoted by the step numbers same as or similar to those in the first embodiment.

First, the gyroscopic sensor 3 detects an angular velocity vector ω, the acceleration sensor 1 detects an acceleration vector al, and the acceleration sensor 2 detects an acceleration vector a₂ (Steps S1, S2, S3). The output from the gyroscopic sensor 3, the output from the acceleration sensor 1, and the output from the acceleration sensor 2 are inputted to the computation unit 4 at a later stage.

Next, based on the output from the gyroscopic sensor 3, the output from the acceleration sensor 1, and the output from the acceleration sensor 2, the computation unit 4 calculates an angular acceleration dω_{z}/dt about the yaw angle using Formula (21) (Step S4). Then, the computation unit 4 corrects the output (the angular velocity) from the gyroscopic sensor 3 by applying a Kalman filter to dω_{z}/dt obtained by Formula (21) and ω_{z} obtained from the output from the gyroscopic sensor 3 (Step S5). Although the Kalman filter is used as an example here, an algorithm for correcting the angular velocity is not limited to this.

Also, the computation unit 4 performs dead zone processing considering the angular acceleration (Step S6). Specifically, the computation unit 4 sets ω=0 if the conditions |ω|<δ₁ and |dω/dt|<δ₂ are both satisfied, and does nothing otherwise.

Further, the computation unit 4 obtains an attitude angle (a pitch angle, a yaw angle) by integrating a derivative of an attitude angle obtained by Formula (38) (Steps S7 to S8).

Meanwhile, the computation unit 4 performs motionlessness determination based on the output from the acceleration sensor 1 and the output from the acceleration sensor 2 (Step S9). Specifically, if the measurement target object is motionless, the computation unit 4 calculates a pitch angle using Formulae (35) and (36) and corrects the pitch angle to be used in Step S7 (Steps 10 to S11). Further, in a case of a rotary motion with one degree of freedom excluding the rotary motions about the roll axis and the pitch axis, i.e., the x-axis and the y-axis, only the rotary motion about the yaw axis needs to be detected. Thus, the composite sensor 10 can be formed of a total of three axes: a single-axis angular velocity sensor for detecting the z-axis, a single-axis acceleration sensor for detecting the x-axis or the y-axis, and a single-axis acceleration sensor for detecting the x-axis or the y-axis. With reference to the drawings, a description is given below on the composite sensor 10 and an angular velocity correction method according to this third embodiment. Note that throughout the drawings, the same or similar parts are denoted by the same or similar reference signs.

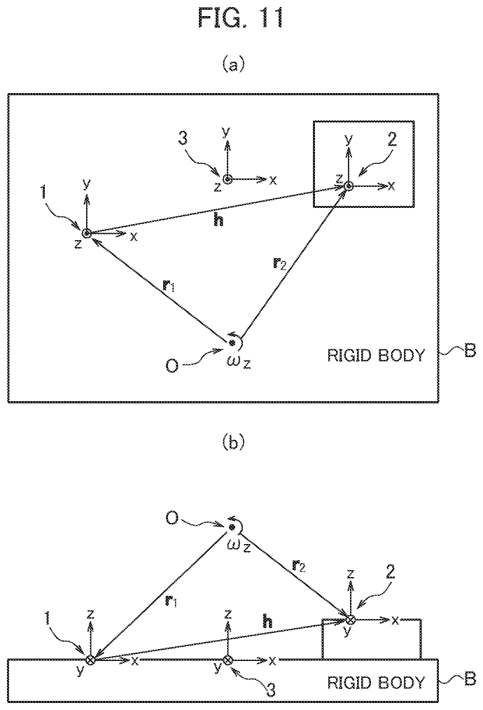

FIG. 11 is a diagram showing an example of how two single-axis acceleration sensors 1, 2 and a single-axis gyroscopic sensor 3 that the composite sensor 10 according to the third embodiment includes are arranged, part (a) being a plan view and part (b) being a side view. The acceleration sensor 1, the acceleration sensor 2, and the gyroscopic sensor 3 respectively correspond to the first acceleration sensor 1, the second acceleration sensor 2, and the angular velocity sensor 3 in FIG. 1 and are therefore described using the same reference signs.

In the third embodiment, as shown in FIG. 11, with the two single-axis acceleration sensors 1, 2 and the single-axis gyroscopic sensor 3 being fixed to a rigid body B, theoretical values of their sensor outputs are calculated using vector analysis.

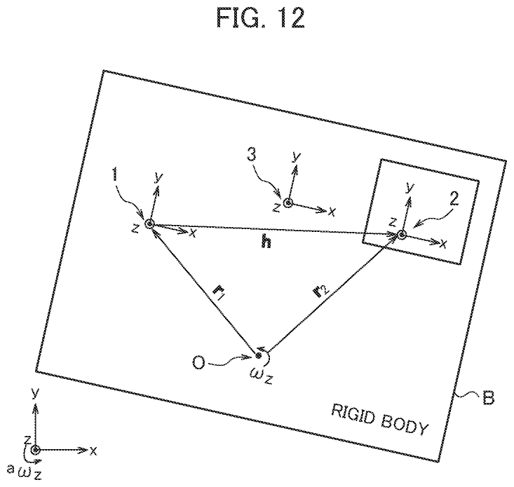

FIG. 12 is a diagram in which a stationary reference coordinate system ΣXYZ is added to FIG. 11 and represents the attitude (yaw angle) of the rigid body B as seen from the stationary reference coordinate system ΣXYZ.

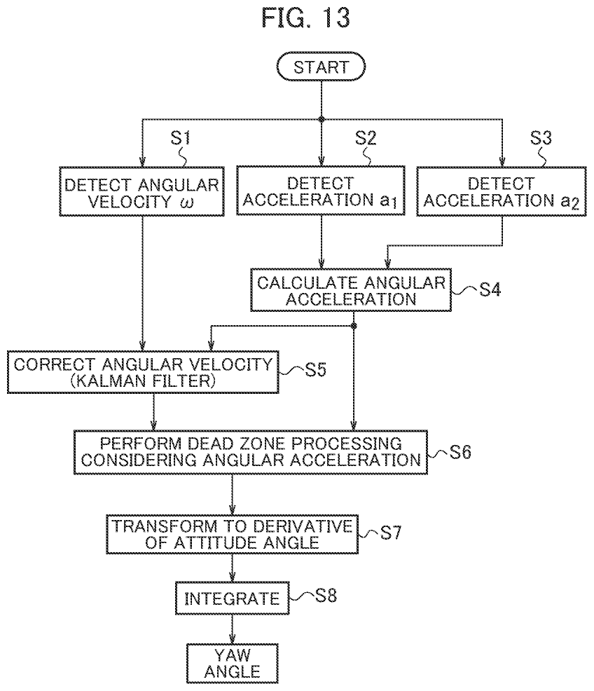

FIG. 13 is a flowchart showing the operation of the composite sensor 10 according to the third embodiment. With reference to FIG. 13, a description is given below on an operation for obtaining an attitude angle using the above-described method. Note that the steps same as or similar to those in the first embodiment are denoted by the step numbers same as or similar to those in the first embodiment.

First, the gyroscopic sensor 3 detects an angular velocity vector ω, the acceleration sensor 1 detects an acceleration vector a₁, and the acceleration sensor 2 detects an acceleration vector a₂ (Steps S1, S2, S3). The output from the gyroscopic sensor 3, the output from the acceleration sensor 1, and the output from the acceleration sensor 2 are inputted to the computation unit 4 at a later stage.

Next, based on the output from the gyroscopic sensor 3, the output from the acceleration sensor 1, and the output from the acceleration sensor 2, the computation unit 4 calculates an angular acceleration dω_{z}/dt about the yaw angle using Formula (21) (Step S4). Then, the computation unit 4 corrects the output (the angular velocity) from the gyroscopic sensor 3 by applying a Kalman filter to dω_{z}/dt obtained by Formula (21) and ω_{z} obtained from the output from the gyroscopic sensor 3 (Step S5). Although the Kalman filter is used as an example here, an algorithm for correcting the angular velocity is not limited to this.

Also, the computation unit 4 performs dead zone processing considering the angular acceleration (Step S6). Specifically, the computation unit 4 sets ω=0 if the conditions |ω|<δ₁ and |dω/dt|<ω₂ are both satisfied, and does nothing otherwise.

Further, the computation unit 4 obtains an attitude angle (a yaw angle) by integrating a derivative of an attitude angle obtained by Formula (38) (Steps S7 to S8).

As described thus far, the composite sensor 10 according to the second embodiment includes the angular velocity sensor 3, the first acceleration sensor 1, the second acceleration sensor 2, and the computation unit 4. The angular velocity sensor 3 detects angular velocity about two axes which are independent of each other. The first acceleration sensor 1 detects acceleration in directions of two axes which are perpendicular to directions of the respective two axes of the angular velocity sensor 3. The second acceleration sensor 2 is disposed at a position which is away in a direction perpendicular to a direction of a first detection axe of the angular velocity sensor 3 and a direction of a first detection axis of the first acceleration sensor 1 and away in a direction perpendicular to a direction of the second detection axis of the angular velocity sensor 3 and a direction of the second detection axis of the first acceleration sensor 1, and the second acceleration sensor 2 detects acceleration in a direction of an axis which is in a plane formed by the two axes detected by the first acceleration sensor 1 and does not coincide with the two axes. The computation unit 4 corrects the angular velocity detected by the angular velocity sensor 3 based on the accelerations detected by the first acceleration sensor 1 and the second acceleration sensor 2. Since the output signal from the angular velocity sensor 3 is thus corrected based on the output signals from the first acceleration sensor 1 and the second acceleration sensor 2, the composite sensor 10 capable of obtaining angular velocity with high precision can be provided.

Also, the composite sensor 10 according to the third embodiment includes the angular velocity sensor 3, the first acceleration sensor 1, the second acceleration sensor 2, and the computation unit 4. The angular velocity sensor 3 detects angular velocity about one axis. The first acceleration sensor 1 detects acceleration in a direction of one axis which is perpendicular to the direction of the one axis of the angular velocity sensor. The second acceleration sensor 2 is disposed at a position away in a direction perpendicular to the direction of the detection axis of the angular velocity sensor 3 and the direction of the detection axis of the first acceleration sensor 1, and detects acceleration in a direction of an axis which is in the same direction as the detection axis of the first acceleration sensor 1. The computation unit 4 corrects the angular velocity detected by the angular velocity sensor 3 based on the accelerations detected by the first acceleration sensor 1 and the second acceleration sensor 2. Since the output signal from the angular velocity sensor 3 is thus corrected based on the output signals from the first acceleration sensor 1 and the second acceleration sensor 2, the composite sensor 10 capable of obtaining angular velocity with high precision can be provided.

The angular velocity correction method according to the second embodiment includes an angular velocity detection step, a first acceleration detection step, a second acceleration detection step, and a computation step. In the angular velocity detection step, the angular velocity sensor 3 detects angular velocity about two axes which are independent of each other. In the first acceleration detection step, the first acceleration sensor 1 detects acceleration in directions of two axes which are perpendicular to directions of the respective two axes of the angular velocity sensor. In the second acceleration detection step, the second acceleration sensor 2 is disposed at a position which is away in the direction perpendicular to the direction of the first detection axis of the angular velocity sensor 3 and the direction of the first detection axis of the first acceleration sensor 1 and which is away in the direction perpendicular to the direction of the second detection axis of the angular velocity sensor 3 and the direction of the second detection axis of the first acceleration sensor 1, and the second acceleration sensor 2 detects acceleration in the direction of the axis which is in the plane formed by the two axes detected by the first acceleration sensor 1 and does not coincide with the two axes. In the computation step, the computation unit 4 corrects the angular velocity detected in the angular velocity detection step based on the accelerations detected in the first acceleration detection step and the second acceleration detection step. Since the output signal from the angular velocity sensor 3 is thus corrected based on the output signals from the first acceleration sensor 1 and the second acceleration sensor 2, an angular velocity correction method capable of obtaining angular velocity with high precision can be provided.

An angular velocity correction method according to the third embodiment includes an angular velocity detection step, a first acceleration detection step, a second acceleration detection step, and a computation step. In the angular velocity detection step, the angular velocity sensor 3 detects angular velocity about one axis. In the first acceleration detection step, the first acceleration sensor 1 detects acceleration in a direction of one axis which is perpendicular to the direction of the one axis of the angular velocity sensor 3. In the second acceleration detection step, the second acceleration sensor 2 is disposed at a position away in the direction perpendicular to the direction of the detection axis of the angular velocity sensor 3 and the direction of the detection axis of the first acceleration sensor 1, and detects acceleration in the direction of the axis which is in the same direction as the detection axis of the first acceleration sensor 1. In the computation step, the computation unit 4 corrects the angular velocity detected in the angular velocity detection step based on the accelerations detected in the first acceleration detection step and the second acceleration detection step. Since the output signal from the angular velocity sensor 3 is thus corrected based on the output signals from the first acceleration sensor 1 and the second acceleration sensor 2, an angular velocity correction method capable of obtaining angular velocity with high precision can be provided.

### Other Embodiments

Preferred embodiments of the present disclosure have been described above by way of example, the present disclosure is not limited to the above embodiments and are variously modifiable. For example, the detailed specifications of the sensor unit S and the computation unit 4 (such as the shapes, sizes, and layouts) can be modified as needed.

The application claims the priority to Japanese Patent Application No. 2019-012259 filed on Jan. 28, 2019, the entire contents of which are incorporated herein by reference.

### INDUSTRIAL APPLICABILITY

The present disclosure can provide a composite sensor and an angular velocity correction method capable of obtaining angular velocity with high precision.

1. A composite sensor comprising:
an angular velocity sensor that detects angular velocity about three axes which are independent of one another;
a first acceleration sensor that detects acceleration in directions of the three axes;
a second acceleration sensor that is disposed at a position away from the first acceleration sensor and detects acceleration in a direction of at least one axis; and
a computation unit that corrects the angular velocity detected by the angular velocity sensor based on the accelerations detected by the first acceleration sensor and the second acceleration sensor.

2. The composite sensor according to claim 1, wherein
the second acceleration sensor is disposed at a position away from the first acceleration sensor not only in a direction of a particular one axis of the three axes.

3. The composite sensor according to claim 2, wherein
when disposition of the second acceleration sensor relative to the first acceleration sensor is a vector h=[hₓ 0 0]^{T}, the second acceleration sensor detects acceleration in a direction orthogonal to both the particular one axis and the vector h.

4. The composite sensor according to claim 1, wherein
the computation unit obtains angular acceleration of a measurement target object based on the accelerations detected by the first acceleration sensor and the second acceleration sensor without using differentiation, and uses the angular acceleration thus obtained to correct the angular velocity detected by the angular velocity sensor.

5. The composite sensor according to claim 4, wherein
when disposition of the second acceleration sensor relative to the first acceleration sensor is a vector h=[hₓ 0 0]^{T}, the computation unit obtains angular acceleration about a z-axis of a measurement target object using Formula (21):
$$\begin{matrix}[ Math . 21 ] & \\ {\dot{ω}}_{z} = \frac{{u}_{2}}{{h}_{x}} - {ω}_{x} {ω}_{y} & ( 21 )\end{matrix}$$
where u₂=a₁−a₂, a₁ is an acceleration vector detected by the first acceleration sensor, and a₂ is an acceleration vector detected by the second acceleration sensor.

6. The composite sensor according to claim 4, wherein
the computation unit sets a dead zone with a magnitude δ₁ for the angular velocity detected by the angular velocity sensor and sets a dead zone with a magnitude δ₂ for the angular acceleration obtained based on the accelerations detected by first acceleration sensor and the second acceleration sensor.

7. An angular velocity correction method comprising:
an angular velocity detection step in which an angular velocity sensor detects angular velocity about three axes which are independent of one another;
a first acceleration detection step in which a first acceleration sensor detects acceleration in directions of the three axes;
a second acceleration detection step in which a second acceleration sensor that is disposed at a position away from the first acceleration sensor detects acceleration in a direction of at least one axis; and
a computation step in which a computation unit corrects the angular velocity detected in the angular velocity detection step based on the accelerations detected in the first acceleration detection step and the second acceleration detection step.

8. A composite sensor comprising:
an angular velocity sensor that detects angular velocity about two axes which are independent of each other;
a first acceleration sensor that detects acceleration in directions of two axes which are perpendicular to directions of the respective two axes of the angular velocity sensor;
a second acceleration sensor that is disposed at a position which is away in a direction perpendicular to a direction of a first one of the detection axes of the angular velocity sensor and a direction of a first one of the detection axes of the first acceleration sensor and also away in a direction perpendicular to a direction of a second one of the detection axes of the angular velocity sensor and a direction of a second one of the detection axes of the first acceleration sensor and that detects acceleration in a direction of an axis which is in a plane formed by the two axes detected by the first acceleration sensor and does not coincide with the two axes; and
a computation unit that corrects the angular velocity detected by the angular velocity sensor based on the accelerations detected by the first acceleration sensor and the second acceleration sensor.

9. A composite sensor comprising:
an angular velocity sensor that detects angular velocity about one axis;
a first acceleration sensor that detects acceleration in a direction of one axis which is perpendicular to a direction of the one axis of the angular velocity sensor;
a second acceleration sensor that is disposed at a position away in a direction perpendicular to the direction of the detection axis of the angular velocity sensor and the direction of the detection axis of the first acceleration sensor, and detects acceleration in a direction of an axis which is in a same direction as the detection axis of the first acceleration sensor; and
a computation unit that corrects the angular velocity detected by the angular velocity sensor, based on the accelerations detected by the first acceleration sensor and the second acceleration sensor.

10. An angular velocity correction method comprising:
an angular velocity detection step in which an angular velocity sensor detects angular velocity about two axes which are independent of each other;
a first acceleration detection step in which a first acceleration sensor detects acceleration in directions of two axes which are perpendicular to directions of the respective two axes of the angular velocity sensor;
a second acceleration detection step in which a second acceleration sensor disposed at a position which is away in a direction perpendicular to a direction of a first one of the detection axes of the angular velocity sensor and a direction of a first one of the detection axes of the first acceleration sensor and away in a direction perpendicular to a direction of a second one of the detection axes of the angular velocity sensor and a direction of a second one of the detection axes of the first acceleration sensor detects acceleration in a direction of an axis which is in a plane formed by the two axes detected by the first acceleration sensor and does not coincide with the two axes; and
a computation step in which a computation unit corrects the angular velocity detected in the angular velocity detection step based on the accelerations detected in the first acceleration detection step and the second acceleration detection step.

11. An angular velocity correction method comprising:
an angular velocity detection step in which an angular velocity sensor detects angular velocity about one axis;
a first acceleration detection step in which a first acceleration sensor detects acceleration in a direction of one axis which is perpendicular to the direction of the one axis of the angular velocity sensor;
a second acceleration detection step in which a second acceleration sensor disposed at a position away in a direction perpendicular to the direction of the detection axis of the angular velocity sensor and the direction of the detection axis of the first acceleration sensor detects acceleration in a direction of an axis which is in a same direction as the detection axis of the first acceleration sensor; and
a computation step in which a computation unit corrects the angular velocity detected in the angular velocity detection step based on the accelerations detected in the first acceleration detection step and the second acceleration detection step.
